(19) United States
(12) Patent Application Publication
(10) Pub. No.: US 2012/0245041 A1
(43) Pub. Date: Sep. 27, 2012

(54) BASE-BY-BASE MUTATION SCREENING

(76) Inventors: Sydney Brenner, Ely (GB); Gi Mikawa, Cambridge (GB)

(21) Appl. No.: 13/501,209

(22) PCT Filed: Oct. 29, 2010
(86) PCT No.: PCT/IB10/03306

§ 371 Date: May 23, 2012

Related U.S. Application Data
(60) Provisional application No. 61/299,182, filed on Jan. 28, 2010.
(60) Provisional application No. 61/258,143, filed on Nov. 4, 2009.

(51) Int. Cl. C40B 20/04

(52) U.S. Cl. 506/4

(57) ABSTRACT

Aspects of the present invention are drawn to screening assays for isolating polynucleotides having a sequence variation or mutation. Embodiments of the screening assays include generating a population of polynucleotide duplexes having 5′ overhang regions on one strand of the duplex (the “template” or “bottom strand”) followed by isolating polynucleotide duplexes from the mixture that have one or more mismatched base at the 3′ end of the other strand of the duplex (the “test” or “top” strand).

A major goal in genetics research is to understand how sequence variations in the genome relate to complex traits, particularly susceptibilities for common diseases such as diabetes, cancer, hypertension, and the like, e.g. Collins et al, Nature, 422: 835-847 (2003). The draft sequence of the human genome has provided a highly useful reference for assessing variation, but it is only a first step towards understanding how the estimated 10 million or more common single nucleotide polymorphisms (SNPs), and other polymorphisms, such as inversions, deletions, insertions, and the like, determine or affect states of health and disease.

### SUMMARY

Aspects of the present invention are drawn to screening assays for isolating polynucleotides having a sequence variation or mutation. Embodiments of the screening assays include generating a population of polynucleotide duplexes having 5′ overhang regions on one strand of the duplex (the “bottom strand”) followed by isolating polynucleotide duplexes from the mixture that have one or more mismatched base at the 3′ end of the other strand of the duplex (the “top” strand).

### BRIEF DESCRIPTION OF THE DRAWINGS

The invention is best understood from the following detailed description when read in conjunction with the accompanying drawings. It is emphasized that, according to common practice, the various features of the drawings are not to-scale. Indeed, the dimensions of the various features are arbitrarily expanded or reduced for clarity. Included in the drawings are the following figures:

FIG. 1 shows exemplary members of a population of polynucleotide duplexes that find use in the mutation analyses described herein.

FIGS. 2A and 2B provide exemplary alternatives for using capture primers and solid phase supports in the mutation analyses described herein.

FIG. 3 provides an exemplary workflow for mutation analyses as described herein.

FIG. 4A provides a schematic of an exemplary polynucleotide having a variety of different structural components that may be employed in the mutation analyses described herein.

FIGS. 4B and 4C show an exemplary reflex process using polynucleotides as shown in FIG. 4A.

FIGS. 5A and 5B show an exemplary embodiments for producing a first strand of a polynucleotide duplexes that may be used in mutational analyses described herein.

FIGS. 6A, 6B and 6C show exemplary embodiments for producing a second strand of a polynucleotide duplexes that may be used in mutational analyses described herein.

FIGS. 7A, 7B, 8 and 9 show schematics for exemplary processes for producing polynucleotide duplexes from precursor duplexes using the first and second strands generated in FIGS. 5A, 5B, 6A, 6B and 6C.

FIGS. 10, 11A, 11B, 11C, 11D and 11E show schematics of exemplary mutational screening of the matched and mismatched polynucleotide duplexes shown in FIG. 9.

FIGS. 12, 13 and 14 provide and exemplary embodiments for obtaining sequence information from the isolated first strands of mismatched polynucleotide duplexes.

FIG. 15 shows a schematic of the duplexes employed in Example I.

FIG. 16 shows the fractionation of the first strands of completely matched, one base mismatched or 10 base mismatched duplexes shown in FIG. 15 (described in Example I).

FIG. 17 shows the results of mismatched duplex “spike in” experiment of Example II. First strands present in the supernatant (S) and bead (E) fractions demonstrates the feasibility of ‘displacing’ perfectly matched sequences from a support while retaining the mismatched (spiked in) sequence on the same support.

FIG. 18 shows the results of further “spike in” experiments (similar to those in Example II), which are described in Example III. This experiment demonstrates that matched and mismatched duplexes produced in a single sample (i.e., by denaturation and hybridization) can be used to isolate mismatched duplexes from matched duplexes.

FIG. 19 shows the formation of ladder of first strands by dNTPαS incorporation, as described in Example IV.

FIG. 20 shows an exemplary schematic of base by base mutation screening according to aspects of the present invention.

FIG. 21 shows results of experiments for detecting a single internal base mismatch.

FIG. 22 shows results of an experiment for selection and subsequent amplification of a polynucleotide having a G/A mismatch.

FIG. 23 shows results of experiments determining the detection sensitivity for identifying and selecting a G/A mismatched chain.

FIG. 24 provides Table 2 which shows mutation coverage of an exemplary mutation detection process according to aspects of the claimed invention.

FIG. 25 provides Table 3 (top and bottom panels) which shows mutations that are detectable by modifications to an exemplary mutation detection system.

### DEFINITIONS

Unless otherwise defined, all technical and scientific terms used herein have the same meaning as commonly understood by one of ordinary skill in the art to which this invention belongs. Still, certain elements are defined for the sake of clarity and ease of reference.

Terms and symbols of nucleic acid chemistry, biochemistry, genetics, and molecular biology used herein follow those of standard treatises and texts in the field, e.g. Kornberg and Baker, DNA Replication, Second Edition (W.H. Freeman, New York, 1992); Lehninger, Biochemistry, Second Edition (Worth Publishers, New York, 1975); Strachan and Read, Human Molecular Genetics, Second Edition (Wiley-Liss, New York, 1999); Eckstein, editor, Oligonucleotides and Analogs: A Practical Approach (Oxford University Press, New York, 1991); Gait, editor, Oligonucleotide Synthesis: A Practical Approach (IRL Press, Oxford, 1984); and the like.

“Amplicon” means the product of a polynucleotide amplification reaction. That is, it is a population of polynucleotides, usually double stranded, that are replicated from one or more starting sequences. The one or more starting sequences may be one or more copies of the same sequence, or it may be a mixture of different sequences. Amplicons may be produced by a variety of amplification reactions whose products are multiple replicates of one or more target nucleic acids. Generally, amplification reactions producing amplicons are “template-driven” in that base pairing of reactants, either nucleotides or oligonucleotides, have complements in a template polynucleotide that are required for the creation of reaction products. In one aspect, template-driven reactions are primer extensions with a nucleic acid polymerase or oligonucleotide ligations with a nucleic acid ligase. Such reactions include, but are not limited to, polymerase chain reactions (PCRs), linear polymerase reactions, nucleic acid sequence-based amplification (NASBAs), rolling circle amplifications, and the like, disclosed in the following references that are incorporated herein by reference: Mullis et al, U.S. Pat. Nos. 4,683,195; 4,965,188; 4,683,202; 4,800,159 (PCR); Gelfand et al, U.S. Pat. No. 5,210,015 (real-time PCR with “TAQMAN™” probes); Wittwer et al, U.S. Pat. No. 6,174,670; Kacian et al, U.S. Pat. No. 5,399,491 (“NASBA”); Lizardi, U.S. Pat. No. 5,854,033; Aono et al, Japanese patent publ. JP 4-262799 (rolling circle amplification); and the like. In one aspect, amplicons of the invention are produced by PCRs. An amplification reaction may be a “real-time” amplification if a detection chemistry is available that permits a reaction product to be measured as the amplification reaction progresses, e.g. “real-time PCR” described below, or “real-time NASBA” as described in Leone et al, Nucleic Acids Research, 26: 2150-2155 (1998), and like references. As used herein, the term “amplifying” means performing an amplification reaction. A “reaction mixture” means a solution containing all the necessary reactants for performing a reaction, which may include, but not be limited to, buffering agents to maintain pH at a selected level during a reaction, salts, co-factors, scavengers, and the like.

The term “assessing” includes any form of measurement, and includes determining if an element is present or not. The terms “determining”, “measuring”, “evaluating”, “assessing” and “assaying” are used interchangeably and includes quantitative and qualitative determinations. Assessing may be relative or absolute. “Assessing the presence of” includes determining the amount of something present, and/or determining whether it is present or absent. As used herein, the terms “determining,” “measuring,” and “assessing,” and “assaying” are used interchangeably and include both quantitative and qualitative determinations.

“Complementary” or “substantially complementary” refers to the hybridization or base pairing or the formation of a duplex between nucleotides or nucleic acids, such as, for instance, between the two strands of a double stranded DNA molecule or between an oligonucleotide primer and a primer binding site on a single stranded nucleic acid. Complementary nucleotides are, generally, A and T (or A and U), or C and G. Two single stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, substantial complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

“Duplex” means at least two oligonucleotides and/or polynucleotides that are fully or partially complementary undergo Watson-Crick type base pairing among all or most of their nucleotides so that a stable complex is formed. The terms “annealing” and “hybridization” are used interchangeably to mean the formation of a stable duplex. “Perfectly matched” in reference to a duplex means that the poly- or oligonucleotide strands making up the duplex form a double stranded structure with one another such that every nucleotide in each strand undergoes Watson-Crick base pairing with a nucleotide in the other strand. A stable duplex can include Watson-Crick base pairing and/or non-Watson-Crick base pairing (e.g., Hoogsteen base pairs) between the strands of the duplex (where base pairing means the forming hydrogen bonds). In certain embodiments, a non-Watson-Crick base pair includes a nucleoside analog, such as deoxyinosine, 2,6-diaminopurine, PNAs, LNA's and the like. In certain embodiments, a non-Watson-Crick base pair includes a “wobble base”, such as deoxyinosine, 8-oxo-dA, 8-oxo-dG and the like, where by “wobble base” is meant a nucleic acid base that can base pair with a first nucleotide base in a complementary nucleic acid strand but that, when employed as a template strand for nucleic acid synthesis, leads to the incorporation of a second, different nucleotide base into the synthesizing strand (wobble bases are described in further detail below). A “mismatch” in a duplex between two oligonucleotides or polynucleotides means that a pair of nucleotides in the duplex fails to undergo Watson-Crick bonding.

“Genetic locus,” “locus,” or “locus of interest” in reference to a genome or target polynucleotide, means a contiguous sub-region or segment of the genome or target polynucleotide. As used herein, genetic locus, locus, or locus of interest may refer to the position of a nucleotide, a gene or a portion of a gene in a genome, including mitochondrial DNA or other non-chromosomal DNA (e.g., bacterial plasmid), or it may refer to any contiguous portion of genomic sequence whether or not it is within, or associated with, a gene. A genetic locus, locus, or locus of interest can be from a single nucleotide to a segment of a few hundred or a few thousand nucleotides in length or more. In general, a locus of interest will have a reference sequence associated with it (see description of “reference sequence” below).

By “isolation”, “isolate”, “isolating” and the like is meant selecting or separating one or more constituents from others in a sample. “Isolating” thus includes producing a sample that has an increased percentage of one or more constituents of interest from a starting sample (e.g., by positive or negative selection). An isolated sample may contain the constituent(s) of interest at anywhere from 1% or more, 5% or more, 10% or more, 50% or more, 75% or more, 90% or more, 95% or more, 99% or more, and up to and including 100% purity. The terms “enriching”, “purifying”, “separating”, “selecting” and the like, are used interchangeably with “isolating”.

“Kit” refers to any delivery system for delivering materials or reagents for carrying out a method of the invention. In the context of reaction assays, such delivery systems include systems that allow for the storage, transport, or delivery of reaction reagents (e.g., probes, enzymes, etc. in the appropriate containers) and/or supporting materials (e.g., buffers, written instructions for performing the assay etc.) from one location to another. For example, kits include one or more enclosures (e.g., boxes) containing the relevant reaction reagents and/or supporting materials. Such contents may be delivered to the intended recipient together or separately. For example, a first container may contain an enzyme for use in an assay, while a second container contains probes.

“Ligation” means to form a covalent bond or linkage between the termini of two or more nucleic acids, e.g. oligonucleotides and/or polynucleotides. The nature of the bond or linkage may vary widely and the ligation may be carried out enzymatically or chemically. As used herein, ligations are usually carried out enzymatically to form a phosphodiester linkage between a 5′ carbon of a terminal nucleotide of one oligonucleotide with 3′ carbon of another oligonucleotide. A variety of template-driven ligation reactions are described in the following references, which are incorporated by reference: Whiteley et al, U.S. Pat. No. 4,883,750; Letsinger et al, U.S. Pat. No. 5,476,930; Fung et al, U.S. Pat. No. 5,593,826; Kool, U.S. Pat. No. 5,426,180; Landegren et al, U.S. Pat. No. 5,871,921; Xu and Kool, Nucleic Acids Research, 27: 875-881 (1999); Higgins et al, Methods in Enzymology, 68: 50-71 (1979); Engler et al, The Enzymes, 15: 3-29 (1982); and Namsaraev, U.S. patent publication 2004/0110213.

“Multiplex Identifier” (MID) as used herein refers to a tag or combination of tags associated with a polynucleotide whose identity (e.g., the tag DNA sequence) can be used to differentiate polynucleotides in a sample. In certain embodiments, the MID on a polynucleotide is used to identify the source from which the polynucleotide is derived. For example, a nucleic acid sample may be a pool of polynucleotides derived from different sources, (e.g., polynucleotides derived from different individuals, different tissues or cells, or polynucleotides isolated at different times points), where the polynucleotides from each different source are tagged with a unique MID. As such, a MID provides a correlation between a polynucleotide and its source. In certain embodiments, MIDs are employed to uniquely tag each individual polynucleotide in a sample. Identification of the number of unique MIDs in a sample can provide a readout of how many individual polynucleotides are present in the sample (or from how many original polynucleotides a manipulated polynucleotide sample was derived; see, e.g., U.S. Pat. No. 7,537,897, issued on May 26, 2009, incorporated herein by reference in its entirety). MIDs are typically comprised of nucleotide bases and can range in length from 2 to 100 nucleotide bases or more and may include multiple subunits, where each different MID has a distinct identity and/or order of subunits. Exemplary nucleic acid tags that find use as MIDs are described in U.S. Pat. No. 7,544,473, issued on Jun. 6, 2009, and titled “Nucleic Acid Analysis Using Sequence Tokens”, as well as U.S. Pat. No. 7,393,665, issued on Jul. 1, 2008, and titled “Methods and Compositions for Tagging and Identifying Polynucleotides”, both of which are incorporated herein by reference in their entirety for their description of nucleic acid tags and their use in identifying polynucleotides. In certain embodiments, a set of MIDs employed to tag a plurality of samples need not have any particular common property (e.g., Tm, length, base composition, etc.), as the methods described herein can accommodate a wide variety of unique MID sets. It is emphasized here that MIDs need only be unique within a given experiment. Thus, the same MID may be used to tag a different sample being processed in a different experiment. In addition, in certain experiments, a user may use the same MID to tag a subset of different samples within the same experiment. For example, all samples derived from individuals having a specific phenotype may be tagged with the same MID, e.g., all samples derived from control (or wildtype) subjects can be tagged with a first MID while subjects having a disease condition can be tagged with a second MID (different than the first MID). As another example, it may be desirable to tag different samples derived from the same source with different MIDs (e.g., samples derived over time or derived from different sites within a tissue). Further, MIDs can be generated in a variety of different ways, e.g., by a combinatorial tagging approach in which one MID is attached by ligation and a second MID is attached by primer extension. Thus, MIDs can be designed and implemented in a variety of different ways to track polynucleotide fragments during processing and analysis, and thus no limitation in this regard is intended.

“Nucleoside” as used herein includes the natural nucleosides, including 2′-deoxy and 2′-hydroxyl forms, e.g. as described in Kornberg and Baker, DNA Replication, 2nd Ed. (Freeman, San Francisco, 1992). “Analogs” in reference to nucleosides includes synthetic nucleosides having modified base moieties and/or modified sugar moieties, e.g. described by Scheit, Nucleotide Analogs (John Wiley, New York, 1980); Uhlman and Peyman, Chemical Reviews, 90: 543-584 (1990), or the like, with the proviso that they are capable of specific hybridization. Such analogs include synthetic nucleosides designed to enhance binding properties, reduce complexity, increase specificity, and the like. Polynucleotides comprising analogs with enhanced hybridization or nuclease resistance properties are described in Uhlman and Peyman (cited above); Crooke et al, Exp. Opin. Ther. Patents, 6: 855-870 (1996); Mesmaeker et al, Current Opinion in Structual Biology, 5: 343-355 (1995); and the like. Exemplary types of polynucleotides that are capable of enhancing duplex stability include oligonucleotide N3′→P5′ phosphoramidates (referred to herein as “amidates”), peptide nucleic acids (referred to herein as “PNAs”), oligo-2′-β-alkylribonucleotides, polynucleotides containing C-5 propynylpyrimidines, locked nucleic acids (“LNAs”), and like compounds. Such oligonucleotides are either available commercially or may be synthesized using methods described in the literature.

Table 1 below shows the IUPAC single letter nucleotide code:

TABLE 1

| IUPAC nucleotide code | Base |
|---|---|
| A | Adenine |
| C | Cytosine |
| G | Guanine |
| T (or U) | Thymine (or Uracil) |
| R | A or G |
| Y | C or T |
| S | G or C |
| W | A or T |
| K | G or T |
| M | A or C |
| B | C or G or T |
| D | A or G or T |
| H | A or C or T |
| V | A or C or G |
| N | any base |

“Polymerase chain reaction,” or “PCR,” means a reaction for the in vitro amplification of specific DNA sequences by the simultaneous primer extension of complementary strands of DNA. In other words, PCR is a reaction for making multiple copies or replicates of a target nucleic acid flanked by primer binding sites, such reaction comprising one or more repetitions of the following steps: (i) denaturing the target nucleic acid, (ii) annealing primers to the primer binding sites, and (iii) extending the primers by a nucleic acid polymerase in the presence of nucleoside triphosphates. Usually, the reaction is cycled through different temperatures optimized for each step in a thermal cycler instrument. Particular temperatures, durations at each step, and rates of change between steps depend on many factors well-known to those of ordinary skill in the art, e.g. exemplified by the references: McPherson et al, editors, PCR: A Practical Approach and PCR2: A Practical Approach (IRL Press, Oxford, 1991 and 1995, respectively). For example, in a conventional PCR using Taq DNA polymerase, a double stranded target nucleic acid may be denatured at a temperature >90° C., primers annealed at a temperature in the range 50-75° C., and primers extended at a temperature in the range 72-78° C. The term “PCR” encompasses derivative forms of the reaction, including but not limited to, RT-PCR, real-time PCR, nested PCR, quantitative PCR, multiplexed PCR, and the like. Reaction volumes typically range from a few hundred nanoliters, e.g. 200 nL, to a few hundred μL, e.g. 200 μL. “Reverse transcription PCR,” or “RT-PCR,” means a PCR that is preceded by a reverse transcription reaction that converts a target RNA to a complementary single stranded DNA, which is then amplified, e.g. Tecott et al, U.S. Pat. No. 5,168,038, which patent is incorporated herein by reference. “Real-time PCR” means a PCR for which the amount of reaction product, i.e. amplicon, is monitored as the reaction proceeds. There are many forms of real-time PCR that differ mainly in the detection chemistries used for monitoring the reaction product, e.g., Gelfand et al, U.S. Pat. No. 5,210,015 (“TAQMAN™”); Wittwer et al, U.S. Pat. Nos. 6,174,670 and 6,569,627 (intercalating dyes); Tyagi et al, U.S. Pat. No. 5,925,517 (molecular beacons); which patents are incorporated herein by reference. Detection chemistries for real-time PCR are reviewed in Mackay et al, Nucleic Acids Research, 30: 1292-1305 (2002), which is also incorporated herein by reference. “Nested PCR” means a two-stage PCR wherein the amplicon of a first PCR becomes the sample for a second PCR using a new set of primers, at least one of which binds to an interior location of the first amplicon. As used herein, “initial primers” in reference to a nested amplification reaction mean the primers used to generate a first amplicon, and “secondary primers” mean the one or more primers used to generate a second, or nested, amplicon. “Multiplexed PCR” means a PCR wherein multiple target sequences (or a single target sequence and one or more reference sequences) are simultaneously carried out in the same reaction mixture, e.g. Bernard et al, Anal. Biochem., 273: 221-228 (1999) (two-color real-time PCR). Usually, distinct sets of primers are employed for each sequence being amplified.

“Quantitative PCR” means a PCR designed to measure the abundance of one or more specific target sequences in a sample or specimen. Quantitative PCR includes both absolute quantitation and relative quantitation of such target sequences. Quantitative measurements are made using one or more reference sequences that may be assayed separately or together with a target sequence. The reference sequence may be endogenous or exogenous to a sample or specimen, and in the latter case, may comprise one or more competitor templates. Typical endogenous reference sequences include segments of transcripts of the following genes: β-actin, GAPDH, β₂-microglobulin, ribosomal RNA, and the like. Techniques for quantitative PCR are well-known to those of ordinary skill in the art, as exemplified in the following references that are incorporated by reference: Freeman et al, Biotechniques, 26: 112-126 (1999); Becker-Andre et al, Nucleic Acids Research, 17: 9437-9447 (1989); Zimmerman et al, Biotechniques, 21: 268-279 (1996); Diviacco et al, Gene, 122: 3013-3020 (1992); Becker-Andre et al, Nucleic Acids Research, 17: 9437-9446 (1989); and the like.

“Polynucleotide” or “oligonucleotide” is used interchangeably and each means a linear polymer of nucleotide monomers. Monomers making up polynucleotides and oligonucleotides are capable of specifically binding to a natural polynucleotide by way of a regular pattern of monomer-to-monomer interactions, such as Watson-Crick type of base pairing, base stacking, Hoogsteen or reverse Hoogsteen types of base pairing, wobble base pairing, or the like. As described in detail below, by “wobble base” is meant a nucleic acid base that can base pair with a first nucleotide base in a complementary nucleic acid strand but that, when employed as a template strand for nucleic acid synthesis, leads to the incorporation of a second, different nucleotide base into the synthesizing strand. Such monomers and their internucleosidic linkages may be naturally occurring or may be analogs thereof, e.g. naturally occurring or non-naturally occurring analogs. Non-naturally occurring analogs may include peptide nucleic acids (PNAs, e.g., as described in U.S. Pat. No. 5,539,082, incorporated herein by reference), locked nucleic acids (LNAs, e.g., as described in U.S. Pat. No. 6,670,461, incorporated herein by reference), phosphorothioate internucleosidic linkages, bases containing linking groups permitting the attachment of labels, such as fluorophores, or haptens, and the like. Whenever the use of an oligonucleotide or polynucleotide requires enzymatic processing, such as extension by a polymerase, ligation by a ligase, or the like, one of ordinary skill would understand that oligonucleotides or polynucleotides in those instances would not contain certain analogs of internucleosidic linkages, sugar moieties, or bases at any or some positions. Polynucleotides typically range in size from a few monomeric units, e.g. 5-40, when they are usually referred to as “oligonucleotides,” to several thousand monomeric units. Whenever a polynucleotide or oligonucleotide is represented by a sequence of letters (upper or lower case), such as “ATGCCTG,” it will be understood that the nucleotides are in 5′→3′ order from left to right and that “A” denotes deoxyadenosine, “C” denotes deoxycytidine, “G” denotes deoxyguanosine, and “T” denotes thymidine, “I” denotes deoxyinosine, “U” denotes uridine, unless otherwise indicated or obvious from context. Unless otherwise noted the terminology and atom numbering conventions will follow those disclosed in Strachan and Read, Human Molecular Genetics 2 (Wiley-Liss, New York, 1999). Usually polynucleotides comprise the four natural nucleosides (e.g. deoxyadenosine, deoxycytidine, deoxyguanosine, deoxythymidine for DNA or their ribose counterparts for RNA) linked by phosphodiester linkages; however, they may also comprise non-natural nucleotide analogs, e.g. including modified bases, sugars, or internucleosidic linkages. It is clear to those skilled in the art that where an enzyme has specific oligonucleotide or polynucleotide substrate requirements for activity, e.g. single stranded DNA, RNA/DNA duplex, or the like, then selection of appropriate composition for the oligonucleotide or polynucleotide substrates is well within the knowledge of one of ordinary skill, especially with guidance from treatises, such as Sambrook et al, Molecular Cloning, Second Edition (Cold Spring Harbor Laboratory, New York, 1989), and like references.

“Primer” means an oligonucleotide, either natural or synthetic, that is capable, upon forming a duplex with a polynucleotide template, of acting as a point of initiation of nucleic acid synthesis and being extended from its 3′ end along the template so that an extended duplex is formed. The sequence of nucleotides added during the extension process is determined by the sequence of the template polynucleotide. Usually primers are extended by a DNA polymerase. Primers are generally of a length compatible with its use in synthesis of primer extension products, and are usually are in the range of between 8 to 100 nucleotides in length, such as 10 to 75, 15 to 60, 15 to 40, 18 to 30, 20 to 40, 21 to 50, 22 to 45, 25 to 40, and so on, more typically in the range of between 18-40, 20-35, 21-30 nucleotides long, and any length between the stated ranges. Typical primers can be in the range of between 10-50 nucleotides long, such as 15-45, 18-40, 20-30, 21-25 and so on, and any length between the stated ranges. In some embodiments, the primers are usually not more than about 10, 12, 15, 20, 21, 22, 23, 24, 25, 26, 27, 28, 29, 30, 35, 40, 45, 50, 55, 60, 65, or 70 nucleotides in length.

Primers are usually single-stranded for maximum efficiency in amplification, but may alternatively be double-stranded. If double-stranded, the primer is usually first treated to separate its strands before being used to prepare extension products. This denaturation step is typically affected by heat, but may alternatively be carried out using alkali, followed by neutralization. Thus, a “primer” is complementary to a template, and complexes by hydrogen bonding or hybridization with the template to give a primer/template complex for initiation of synthesis by a polymerase, which is extended by the addition of covalently bonded bases linked at its 3′ end complementary to the template in the process of DNA synthesis.

A “primer pair” as used herein refers to first and second primers having nucleic acid sequence suitable for nucleic acid-based amplification of a target nucleic acid. Such primer pairs generally include a first primer having a sequence that is the same or similar to that of a first portion of a target nucleic acid, and a second primer having a sequence that is complementary to a second portion of a target nucleic acid to provide for amplification of the target nucleic acid or a fragment thereof. Reference to “first” and “second” primers herein is arbitrary, unless specifically indicated otherwise. For example, the first primer can be designed as a “forward primer” (which initiates nucleic acid synthesis from a 5′ end of the target nucleic acid) or as a “reverse primer” (which initiates nucleic acid synthesis from a 5′ end of the extension product produced from synthesis initiated from the forward primer). Likewise, the second primer can be designed as a forward primer or a reverse primer.

“Readout” means a parameter, or parameters, which are measured and/or detected that can be converted to a number or value. In some contexts, readout may refer to an actual numerical representation of such collected or recorded data. For example, a readout of fluorescent intensity signals from a microarray is the address and fluorescence intensity of a signal being generated at each hybridization site of the microarray; thus, such a readout may be registered or stored in various ways, for example, as an image of the microarray, as a table of numbers, or the like.

“Reflex site”, “reflex sequence” and equivalents are used to indicate one or more sequences present in a polynucleotide that are employed to move a domain intra-molecularly from its initial location to a different location in the polynucleotide. The use of reflex sequences is described in detail in U.S. provisional applications 61/235,595 and 61/288,792, filed on Aug. 20, 2009 and Dec. 21, 2009, respectively, and entitled “Compositions and Methods for Intramolecular Nucleic Acid Rearrangement Using Reflex Sequences”, both of which are incorporated herein by reference. In certain embodiments, a reflex sequence is chosen so as to be distinct from other sequences in the polynucleotide (i.e., with little sequence homology to other sequences likely to be present in the polynucleotide, e.g., genomic or sub-genomic sequences to be processed). As such, a reflex sequence should be selected so as to not hybridize to any sequence except its complement under the conditions employed in the reflex processes. The reflex sequence may be a synthetic or artificially generated sequence (e.g., added to a polynucleotide in an adapter domain) or a sequence present normally in a polynucleotide being assayed (e.g., a sequence present within a region of interest in a polynucleotide being assayed). In the reflex system, a complement to the reflex sequence is present (e.g., inserted in an adapter domain) on the same strand of the polynucleotide as the reflex sequence (e.g., the same strand of a double-stranded polynucleotide or on the same single stranded polynucleotide), where the complement is placed in a particular location so as to facilitate an intramolecular binding and polymerization event on such particular strand. Reflex sequences employed in the reflex process described herein can thus have a wide range of lengths and sequences. Reflex sequences may range from 5 to 200 nucleotide bases in length.

“Solid support”, “support”, and “solid phase support” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. Microarrays usually comprise at least one planar solid phase support, such as a glass microscope slide.

“Specific” or “specificity” in reference to the binding of one molecule to another molecule, such as a labeled target sequence for a probe, means the recognition, contact, and formation of a stable complex between the two molecules, together with substantially less recognition, contact, or complex formation of that molecule with other molecules. In one aspect, “specific” in reference to the binding of a first molecule to a second molecule means that to the extent the first molecule recognizes and forms a complex with another molecule in a reaction or sample, it forms the largest number of the complexes with the second molecule. Preferably, this largest number is at least fifty percent. Generally, molecules involved in a specific binding event have areas on their surfaces or in cavities giving rise to specific recognition between the molecules binding to each other. Examples of specific binding include antibody-antigen interactions, enzyme-substrate interactions, formation of duplexes or triplexes among polynucleotides and/or oligonucleotides, receptor-ligand interactions, and the like. As used herein, “contact” in reference to specificity or specific binding means two molecules are close enough that weak noncovalent chemical interactions, such as Van der Waal forces, hydrogen bonding, base-stacking interactions, ionic and hydrophobic interactions, and the like, dominate the interaction of the molecules.

As used herein, the term “Tₘ” is used in reference to the “melting temperature.” The melting temperature is the temperature (e.g., as measured in ° C.) at which a population of double-stranded nucleic acid molecules becomes half dissociated into single strands. Several equations for calculating the Tₘ of nucleic acids are known in the art (see e.g., Anderson and Young, Quantitative Filter Hybridization, in Nucleic Acid Hybridization (1985). Other references (e.g., Allawi, H. T. & SantaLucia, J., Jr., Biochemistry 36, 10581-94 (1997)) include alternative methods of computation which take structural and environmental, as well as sequence characteristics into account for the calculation of Tₘ.

“Sample” means a quantity of material from a biological, environmental, medical, or patient source in which detection, measurement, or labeling of target nucleic acids is sought. On the one hand it is meant to include a specimen or culture (e.g., microbiological cultures). On the other hand, it is meant to include both biological and environmental samples. A sample may include a specimen of synthetic origin. Biological samples may be animal, including human, fluid, solid (e.g., stool) or tissue, as well as liquid and solid food and feed products and ingredients such as dairy items, vegetables, meat and meat by-products, and waste. Biological samples may include materials taken from a patient including, but not limited to cultures, blood, saliva, cerebral spinal fluid, pleural fluid, milk, lymph, sputum, semen, needle aspirates, and the like. Biological samples may be obtained from all of the various families of domestic animals, as well as feral or wild animals, including, but not limited to, such animals as ungulates, bear, fish, rodents, etc. Environmental samples include environmental material such as surface matter, soil, water and industrial samples, as well as samples obtained from food and dairy processing instruments, apparatus, equipment, utensils, disposable and non-disposable items. These examples are not to be construed as limiting the sample types applicable to the present invention.

The terms “upstream” and “downstream” in describing nucleic acid molecule orientation and/or polymerization are used herein as understood by one of skill in the art. As such, “downstream” generally means proceeding in the 5′ to 3′ direction, i.e., the direction in which a nucleotide polymerase normally extends a sequence, and “upstream” generally means the converse. For example, a first primer that hybridizes “upstream” of a second primer on the same target nucleic acid molecule is located on the 5′ side of the second primer (and thus nucleic acid polymerization from the first primer proceeds towards the second primer).

It is further noted that the claims may be drafted to exclude any optional element. As such, this statement is intended to serve as antecedent basis for use of such exclusive terminology as “solely”, “only” and the like in connection with the recitation of claim elements, or the use of a “negative” limitation.

### DETAILED DESCRIPTION OF THE INVENTION

Aspects of the invention are drawn to compositions and methods for analysis of mutations (or variants) of one or more polynucleotide that find use in various applications.

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

It must be noted that as used herein and in the appended claims, the singular forms “a”, “an”, and “the” include plural referents unless the context clearly dictates otherwise. Thus, for example, reference to “a nucleic acid” includes a plurality of such nucleic acids and reference to “the compound” includes reference to one or more compounds and equivalents thereof known to those skilled in the art, and so forth.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, New York, Gait, “Oligonucleotide Synthesis: A Practical Approach” 1984, IRL Press, London, Nelson and Cox (2000), Lehninger, A., Principles of Biochemistry 3^{rd} Ed., W. H. Freeman Pub., New York, N.Y. and Berg et al. (2002) Biochemistry, 5^{th} Ed., W. H. Freeman Pub., New York, N.Y., all of which are herein incorporated in their entirety by reference for all purposes.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

As noted above, aspects of the invention are drawn to compositions and methods for analysis of mutations (or variants) of one or more polynucleotide that find use in various applications.

### Polynucleotides and Polynucleotide Samples

The mutation screening described herein can be employed for the analysis of polynucleotides from virtually any source, including but not limited to genomic DNA, complementary DNA (cDNA), RNA (e.g., messenger RNA, ribosomal RNA, short interfering RNA, microRNA, etc.), plasmid DNA, mitochondrial DNA, etc. Furthermore, as any organism can be used as a source of polynucleotides to be processed in accordance with the present invention, no limitation in that regard is intended. Exemplary organisms include, but are not limited to, plants, animals (e.g., reptiles, mammals, insects, worms, fish, etc.), bacteria, fungi (e.g., yeast), viruses, etc. In certain embodiments, the polynucleotides are derived from a mammal, where in certain embodiments the mammal is a human.

In certain embodiments, polynucleotides are enriched prior to mutation screening. By enriched is meant that the polynucleotides are subjected to a process that reduces the complexity of the polynucleotides, generally by increasing the relative concentration of particular polynucleotide species in the sample (e.g., having a specific locus of interest, including a specific polynucleotide sequence, lacking a locus or sequence, being within a specific size range, etc.). There are a wide variety of ways to enrich polynucleotides having a specific characteristic(s) or sequence, and as such any convenient method to accomplish this may be employed. The enrichment (or complexity reduction) can take place at any of a number of steps in the process, and will be determined by the desires of the user. For example, enrichment can take place in individual parental samples (e.g., untagged polynucleotides prior to adaptor ligation) or in multiplexed samples (e.g., polynucleotides tagged with primer binding sites, MID and/or reflex sequences and pooled; MID are described in further detail below).

In certain embodiments, polynucleotides in the polynucleotide sample are amplified prior to analysis. In certain of these embodiments, the amplification reaction also serves to enrich a starting polynucleotide sample for a sequence or locus of interest. For example, a starting polynucleotide sample can be subjected to a polymerase chain reaction (PCR) that amplifies one or more region of interest. In certain embodiments, the amplification reaction is an exponential amplification reaction, whereas in certain other embodiments, the amplification reaction is a linear amplification reaction. Any convenient method for performing amplification reactions on a starting polynucleotide sample can be used in practicing the subject invention. In certain embodiments, the nucleic acid polymerase employed in the amplification reaction is a polymerase that has proofreading capability (e.g., phi29 DNA Polymerase, Thermococcus litoralis DNA polymerase, Pyrococcus furiosus DNA polymerase, etc.).

In certain embodiments, the polynucleotide sample being analyzed is derived from a single source (e.g., a single organism, virus, tissue, cell, subject, etc.), whereas in other embodiments, the polynucleotide sample is a pool of polynucleotides extracted from a plurality of sources (e.g., a pool of polynucleotides from a plurality of organisms, tissues, cells, subjects, etc.), where by “plurality” is meant two or more. As such, in certain embodiments, a polynucleotide sample can contain polynucleotides from 2 or more sources, 3 or more sources, 5 or more sources, 10 or more sources, 50 or more sources, 100 or more sources, 500 or more sources, 1000 or more sources, 5000 or more sources, up to and including about 10,000 or more sources.

In certain embodiments, polynucleotide fragments that are to be pooled with polynucleotide fragments derived from a plurality of sources (e.g., a plurality of organisms, tissues, cells, subjects, etc.), where by “plurality” is meant two or more. In such embodiments, the polynucleotides derived from each source include a multiplex identifier (MID) such that the source from which the each tagged polynucleotide fragment was derived can be determined. In such embodiments, each polynucleotide sample source is correlated with a unique MID, where by unique MID is meant that each different MID employed can be differentiated from every other MID employed by virtue of at least one characteristic, e.g., the nucleic acid sequence of the MID. Any type of MID can be used, including but not limited to those described in co-pending U.S. patent application Ser. No. 11/656,746, filed on Jan. 22, 2007, and titled “Nucleic Acid Analysis Using Sequence Tokens”, as well as U.S. Pat. No. 7,393,665, issued on Jul. 1, 2008, and titled “Methods and Compositions for Tagging and Identifying Polynucleotides”, both of which are incorporated herein by reference in their entirety for their description of nucleic acid tags and their use in identifying polynucleotides. In certain embodiments, a set of MIDs employed to tag a plurality of samples need not have any particular common property (e.g., Tₘ, length, base composition, etc.), as the methods described herein can accommodate a wide variety of unique MID sets.

In certain embodiments, each individual polynucleotide (e.g., double-stranded or single-stranded, as appropriate to the methodological details employed) in a sample to be analyzed is tagged with a unique MID so that the fate of each polynucleotide can be tracked in subsequent processes (where, as noted above, unique MID is meant to indicate that each different MID employed can be differentiated from every other MID employed by virtue of at least one characteristic, e.g., the nucleic acid sequence of the MID). For example (and as described below), having each nucleic acid tagged with a unique MID allows analysis of variants/mutations in the sequence of each individual nucleic acid using the screening methods described herein.

### Isolation of Polynucleotide Duplexes Having a Mismatch

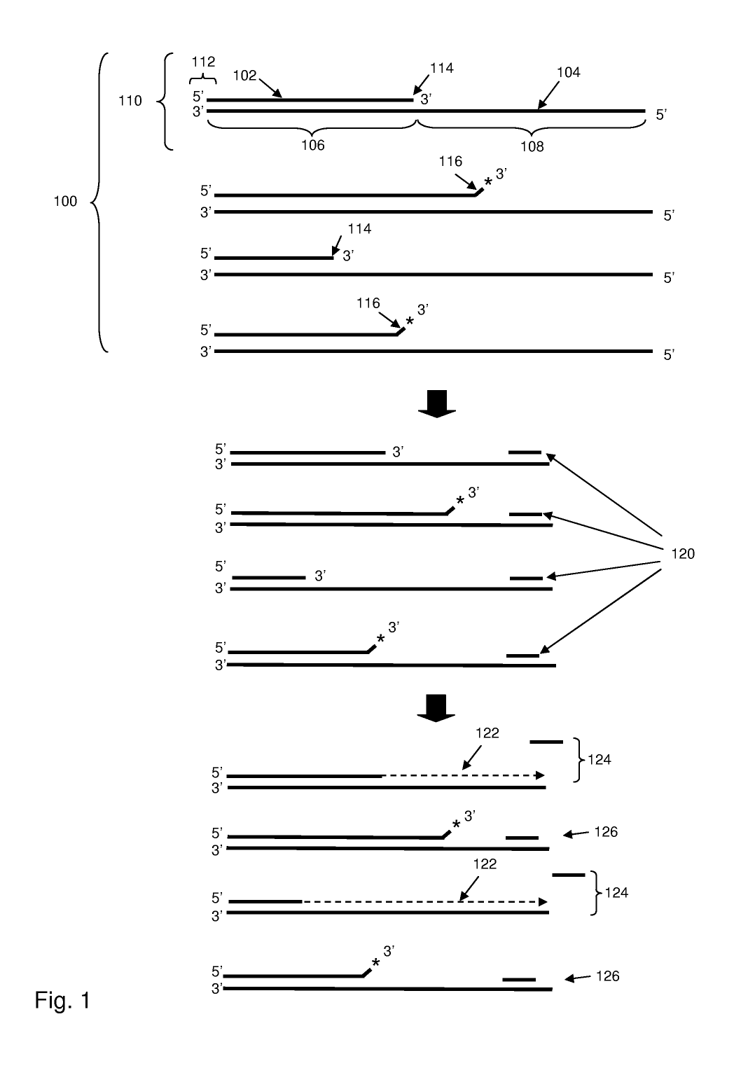

Aspects of the present invention include isolating, from a population of polynucleotide duplexes, one or more polynucleotide duplex having at least one mismatched nucleotide. FIG. 1 provides an exemplary schematic of this process.

FIG. 1 shows exemplary members of a population of polynucleotide duplexes 100. The polynucleotide duplexes include a first strand 102 and a second strand 104 that produce a duplex region 106 and a 5′ overhang region 108 (these regions are indicated only on duplex 110 but are present on each duplex shown). As shown in FIG. 1, the 5′ overhang region is a single stranded region at the 5′ end of the second strand 104. The duplex region of the polynucleotide duplexes include regions of the first and second strands that are substantially complementary to one another and thus can form hybridization complexes under hybridization conditions, such as stringent hybridization conditions. These regions of the first and second strands are sometimes individually referred to as duplex regions, regions of substantial complementarity, hybridization regions, or variations thereof. As shown in FIG. 1, the duplex region of one polynucleotide duplex in the population is not necessarily that same as the duplex region of another polynucleotide duplex. As such, the duplex regions can have different sequences, lengths, orientations, etc. In certain embodiments, the duplexes in the population have duplex regions of a variety of different lengths. In certain of these embodiments, the duplex regions are overlapping duplex regions that span all of part of a common region of interest, such as a specific genomic region. As such, a wide variety of different populations of polynucleotide duplexes may be subjected to the isolation process described herein.

The end opposite the 5′ overhang region of the second strand in the polynucleotide duplexes 112 may be blunt or include 3′ recesses or 3′ overhangs (with regard to the second strand). A sample of polynucleotide duplexes employed in the isolation steps described herein may contain polynucleotide duplexes that have similar end structures opposite the 5′ overhang region (e.g., all have blunt ends) or contain polynucleotide duplexes that have different end structures opposite the 5′ overhang region (e.g., a mixture of blunt ends, 3′ overhang and/or 3′ recessed ends). In addition, the duplex region may or may not extend to the end opposite the 5′ overhang region. In other words, the region at the 5′ end of the first strand or the 3′ end of the second strand may not be included in the duplex region. Further, as described elsewhere herein, the ends opposite the 5′ overhang region of polynucleotide duplexes may include any of a variety of modifications, such as those that facilitate previous or subsequent processing and/or analysis steps. For example, the region opposite the 5′ overhang region of the polynucleotide duplexes may contain a Multiplex Identifier (MID) that can be used to correlate each duplex with its source of origin. As such, no limitation with regard to the end opposite of the 5′ overhang region is intended.

As shown in the exemplary embodiment of FIG. 1, the population of polynucleotide duplexes in the sample (sometimes referred to as a ladder of duplexes; described in further detail below) includes one or more polynucleotide duplexes having a matched 3′ terminal nucleotide on the first strand 114 and one or more polynucleotide duplexes having a mismatched 3′ terminal nucleotide on the first strand 116. The mismatch 116 is indicated by an asterisk (*). In certain embodiments, the 3′ terminal nucleotide on the first strand is resistant to exonuclease activity (e.g., by Exonuclease III or by the proofreading activity of DNA polymerases, e.g., Klenow or phi29 DNA polymerase). Exemplary resistant nucleotides include those having alternative internucleosidic linkages, e.g., thio-phosphate or borano-phosphate internucleosidic linkages.

As shown in the exemplary embodiment of FIG. 1, a capture primer 120 is annealed to the 5′ overhang region of the polynucleotide duplexes. In certain embodiments, the capture primer anneals to a common site present in the polynucleotide duplexes, also called a capture primer binding site. The capture primer binding site may be one that is present normally in the polynucleotides being processed (e.g., a genomic site) or one that has been attached to the second strand (e.g., in an adapter domain attached previously). In certain embodiments, more than one capture primer may be used in a single sample. For example, in a mixture of polynucleotides duplexes that include at least two duplexes that have different capture primer binding sites (i.e., capture primer binding sites with different nucleotide sequences), a mixture of capture primers specific for each different capture primer binding site may be used.

As shown in FIG. 1, the annealing step results in the formation of polynucleotide duplexes in which a capture primer is annealed to the second strand of a duplex at a position that is downstream of the 3′ terminal nucleotide of the first strand of the same duplex (in other words, the 3′ terminal nucleotide of the first strand is upstream of the annealed capture primer). As noted elsewhere, by “upstream” and “downstream” is meant the relative position on a polynucleotide strand in reference to the direction in which nucleic acid synthesis proceeds using that strand as a template.

Following the annealing step, capture primer-annealed polynucleotide duplexes are contacted with a nucleic acid polymerase having 5′ to 3′ strand displacement activity under nucleic acid synthesis conditions. Under these conditions, nucleic acid synthesis is initiated from the 3′ end of the first strand in duplexes in which the terminal 3′ nucleotide of the first strand is matched to the corresponding base in the second strand (i.e., the terminal 3′ nucleotide of the first strand base-pairs with the corresponding nucleotide in the second strand). Nucleic acid synthesis then proceeds through the 5′ overhang region, using the second strand as the template (see dotted arrows 122). Because the nucleic acid polymerase employed has 5′ to 3′ strand displacement activity, the capture primers downstream of first strands having matched 3′ terminal nucleotides are displaced from the second strand 124. Conversely, on duplexes in which the terminal 3′ nucleotide of the first strand is not matched to the second strand (i.e., the terminal 3′ nucleotide of the first strand does not base-pair with the corresponding nucleotide in the second strand), nucleic acid synthesis cannot be initiated by the nucleic acid polymerase and the capture primer remains annealed to the second strand 126. This process exploits the inability of DNA polymerases to initiate synthesis from a primer having a mismatched terminal 3′ nucleotide (see, e.g., Low, et al. Analysis of the amplification refractory mutation allele-specific polymerase chain reaction system for sensitive and specific detection of p53 mutations in DNA, J Pathol 2000, 190:512-5; Hodgson, et al. ARMS™—Allele-specific Amplification based Detection of Mutant p53 DNA and mDNA in tumours of the breast. Clinical Chemistry 2001 47(4):774-778; both of which are incorporated by reference herein in their entirety).

In embodiments in which the 3′ terminal nucleotide base of the first strand is resistant to exonuclease digestion (e.g., has thio-phosphate linkage, as noted above), a proofreading DNA polymerase may be used for the extension reaction. Such polymerases include, e.g., Klenow, phi29, Vent, Deep Vent, and 9 degree N. In certain embodiments, a combination of two DNA polymerases may be employed: one having proofreading activity (such as T4 or T7 DNA polymerase) and the other having 5′ to 3′ strand displacement activity (such as MMLV reverse transcriptase). The presence of the exonuclease-resistant base prevents the proofreading activity of the DNA polymerase from removing the 3′ terminal mismatched base (or bases) from the first strand and initiating nucleic acid synthesis from a preceding matched base, which would erroneously displace the capture primer from a mismatched duplex.

It is noted here that the phosphorothioate linkage sensitivity of the exonuclease used to generate a ladder of duplexes (or any other exonuclease-resistant linkage) should be similar to that of the exonuclease activity of the proofreading polymerase. For example if exonuclease III is used in generating the matched/mismatched duplexes, then the exonuclease activity of the proofreading DNA polymerase should be similar to that of exonuclease III. This will insure that a mismatched base that is resistant to the exonuclease employed to make the duplex will not be removed by the exonuclease activity of the proof-reading DNA polymerase in subsequent steps of the process. As noted above, removal of a terminal 3′ mismatched base by the proof-reading polymerase would make it impossible to identify the mismatched duplex using DNA polymerase in subsequent steps.

In certain embodiments, a non-proofreading DNA polymerase may be used in conjunction with a second enzyme having proofreading/exonuclease activity for the extension reaction. As one non-limiting example, a combination of Sequenase and exonuclease III may be employed in the extension reaction.

It is noted here that any duplex structure in which the 3′ terminal nucleotide is not base paired with the second strand will prevent initiation of nucleic acid synthesis and capture primer displacement. For example, the last 2, 3, 4, or more 3′ terminal bases of the first strand may be mismatched with the second strand. As such, no limitation in this regard is intended.

After the contacting step, duplexes containing non-displaced capture primers are isolated. This isolation step can be achieved in any convenient manner.

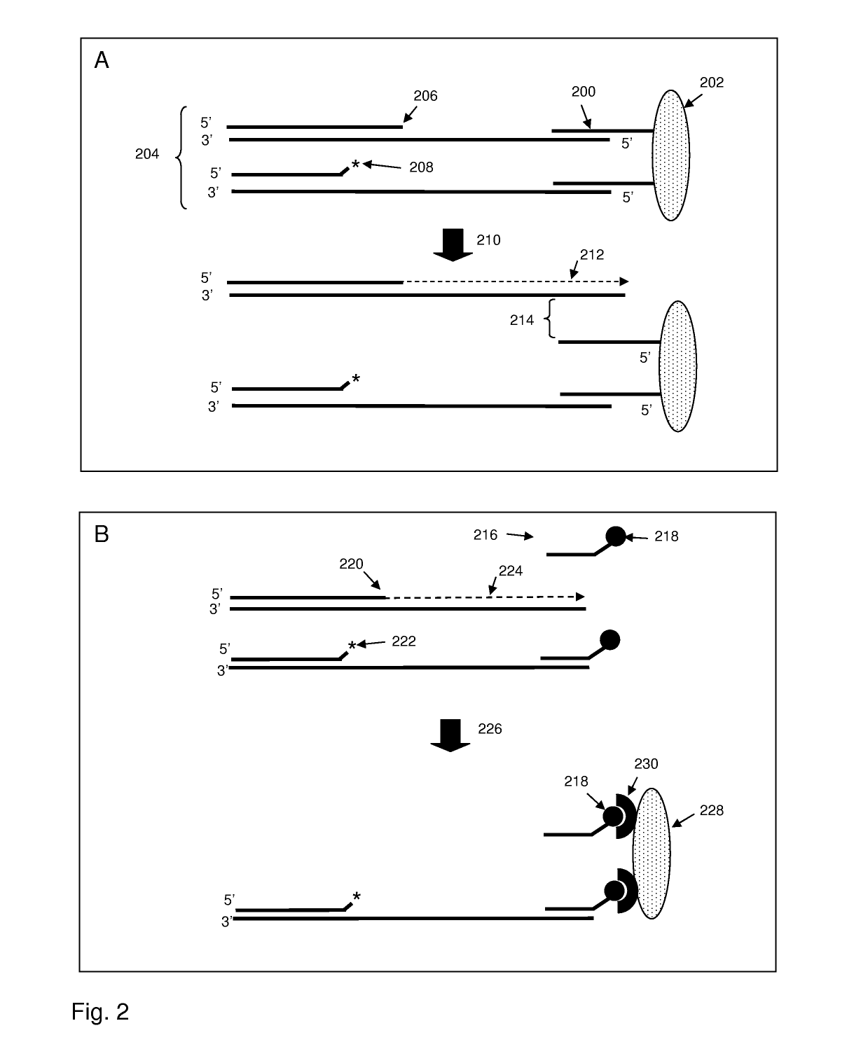

In certain embodiments, the capture primer employed is immobilized on a solid phase support prior to the nucleic acid synthesis step, as exemplified in the schematic in FIG. 2A. In FIG. 2A, capture primers 200 attached to solid phase support 202 are annealed to duplexes 204, which includes a duplexes having a matched and mismatched 3′ terminal nucleotide on the first strand (206 and 208, respectively). The substrate (or substrates, depending on the embodiment) with the immobilized duplexes are then subjected to nucleic acid synthesis conditions 210. Duplexes in which nucleic acid synthesis is initiated (i.e., having matched 3′ terminal bases on the first strand; dotted line 212) are displaced from the solid support (shown by bracket 214) into the supernatant when the capture primer is displaced by the 5′ to 3′ displacement activity of the nucleic acid polymerase employed in the synthesis step Duplexes having mismatched 3′ terminal bases on the first strand do not initiate nucleic acid synthesis, and thus are not displaced from the solid phase substrate into the supernatant. In certain embodiments, these substrate-bound duplexes (mismatched duplexes) are washed and then eluted (e.g., by placing under denaturing conditions to elute from the capture primer or by cleavage from the substrate) and subjected to further processing as desired by the user. In certain embodiments, the substrate-bound duplexes may be subjected to one or more additional rounds of nucleic acid synthesis prior to the eluting step to reduce the level of matched-duplex background (i.e., to displace substrate-bound matched duplexes that did not undergo nucleic acid synthesis in the first round, and thus were not displaced from the capture primer). Alternatively, biochemical steps such as ligation or use of terminal transferase with dideoxy nucleotides may be employed to block any residual matched-duplex from the processing steps which are used, as described below, on the mismatched-duplex. The capture primer may be attached to the solid phase support in any convenient manner, either covalently or non-covalently (e.g., using binding partner pairs, as described below).

In certain other embodiments, the nucleic acid synthesis step is performed on capture primer annealed duplexes that are not immobilized on a solid phase surface (i.e., free in solution) followed by isolation of duplexes having annealed capture primers, as exemplified in the schematic in FIG. 2B. In FIG. 2B, capture primer 216, having a binding moiety 218 thereon, is annealed to polynucleotide duplexes having both matched and mismatched 3′ terminal bases on the first strand, 220 and 222 respectively. Under nucleic acid synthesis conditions, the capture primer is displaced from matched duplexes (i.e., duplexes having matched 3′ terminal nucleotides; see dotted arrow 224) but is left annealed on mismatched duplexes (i.e., duplexes having mismatched 3′ terminal nucleotides). In step 226, the sample is contacted to a solid phase support 228 that has attached thereto a binding partner 230 for the binding moiety 218 present on the capture primer 216. Because the capture primer has not been displaced from duplexes having first strand 3′ terminal base mismatches, these duplexes will be attached to the solid support via the capture primer (free/displaced capture primers will also bind to the solid phase support). Duplexes in which the capture primer has been displaced will remain in the supernatant. The duplexes bound to the solid phase support can be eluted from the support for further processing as desired by the user. Binding moieties and their corresponding binding partners are also referred to herein as binding partner pairs. Any convenient binding partner pairs may be used, including but not limited to biotin/avidin (or streptavidin), antigen/antibody pairs, or any of a variety of other protein-protein, protein-nucleic acid, nucleic acid-nucleic acid, or magnetic binding partner pairs.

In certain other embodiments, an extension reaction can be performed in solution prior to annealing the capture primer, where the extension reaction includes biotinylated deoxynucleotide triphosphates. In this embodiment, initiation of nucleic polymerization from a matched 3′ end will lead to the incorporation of biotinylated bases, regardless of whether the polymerization is completed (i.e., regardless of whether nucleic acid polymerization reaches the 5′ end of the second strand). Both fully extended and partially extended matched duplexes can then be removed using a streptavidin coated substrate (e.g., bead). Following removal of fully or partially extended duplexes, the remaining non-matched duplexes can be immobilized by annealing a capture primer (e.g., annealing an immobilized capture primer or a binding moiety labeled capture primer followed by contacting to a binding partner-coated support, as described above).

It is noted here that the steps of capture primer annealing, nucleic acid synthesis and solid phase support binding can be performed in any order that results in the isolation of duplexes that have mismatched 3′ terminal nucleotides on the first strand. For example, the capture primer can be bound to a solid phase support used in the isolation step before annealing the capture primer to the 5′ overhang region of the duplexes in the sample, after annealing but before the nucleic acid synthesis/displacement reaction, or after the nucleic acid synthesis/displacement reaction.

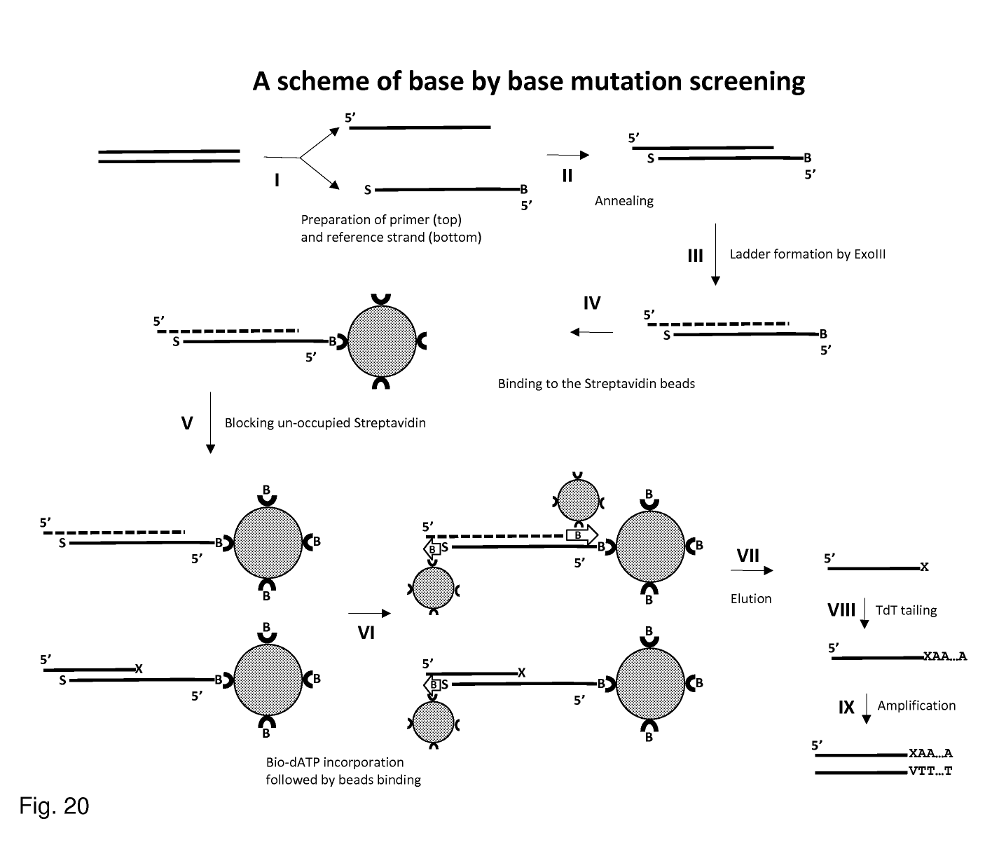

It is further noted that in certain other embodiments, capture primers are not employed in the isolation of polynucleotide duplexes having mismatched 3′ bases, and thus can be omitted (see additional description variations of mismatched-strand isolation below, e.g., as shown in FIG. 20).

The implementation of a duplex isolation step using the methods described above or variations thereof will generally be based on the desires of the user.

### Exemplary Workflow Incorporating Isolation of Polynucleotide Duplexes Having a Mismatch

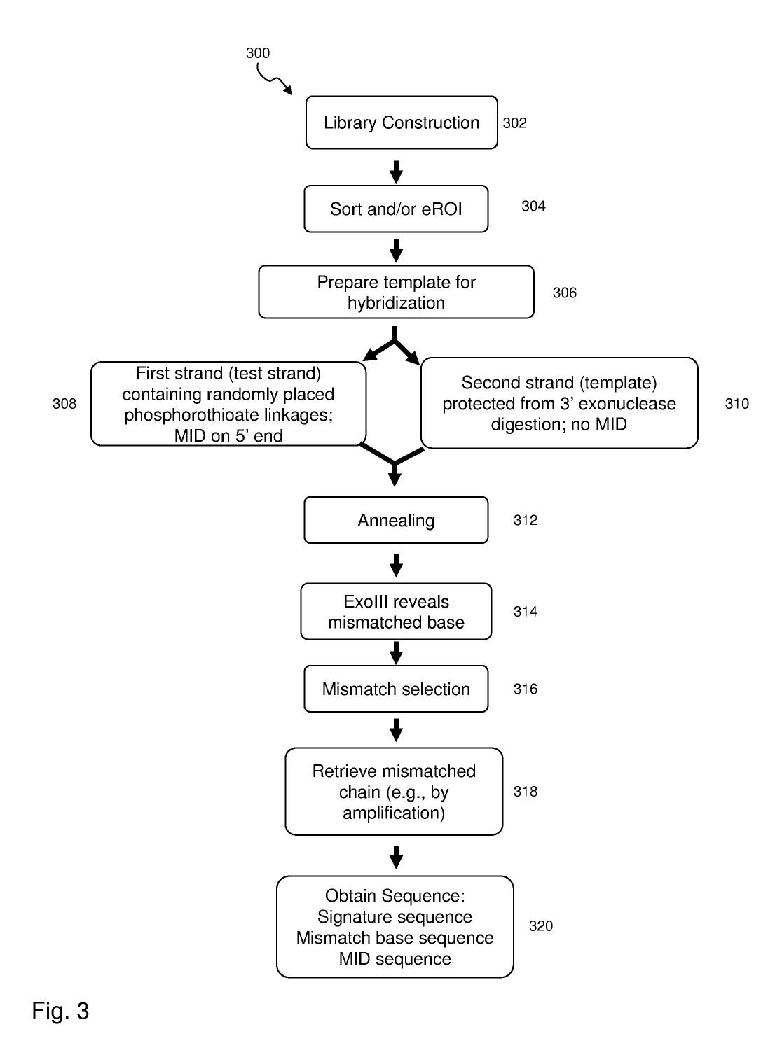

The isolation of polynucleotide duplexes having a mismatch detailed above can be used in any number of different genetic workflows, we provide below a description of an exemplary workflow. FIG. 3 provides an overview 300 of this workflow.

In step 302, a library is constructed that includes polynucleotides derived from multiple different sources (e.g., genomic DNA from multiple individuals), with the polynucleotides having MIDs that correlate with their source of origin. At step 304, polynucleotides are selected from the library for analysis. For example, polynucleotides having a specific region of interest (ROI) can be selected, e.g., polynucleotides having a region from a specific gene or region of the genome. This selection process is referred to in FIG. 3 as “Sort and/or eROI” and may be done alone or in combination with other selection techniques such as sequenced based sorting (e.g., as described in U.S. Pat. No. 7,217,522, issued May 15, 2007). From this selected sample, polynucleotides for hybridization are prepared 306. First strands (also called test strands) for duplex formation are prepared that include one or more randomly placed phosphorothioate linkages and include an MID in step 308 (it is noted that other resistant inter-nucleosidic linkages other than phosphorothioate linkages may be used, e.g., borano-phosphate as detailed below). These first/test strands can be considered as the strands from the multiplexed sample that are being interrogated for nucleotide variations/mutations. Second strands (template) are prepared in step 310 which lack an MID and are protected from exonuclease activity at the 3′ end (e.g., they include multiple consecutive phosphorothioate linkages at the 3′ end). In certain embodiments, the template strands also include an adapter region at the 5′ end (e.g., which contains a capture primer binding site). The second strand can be considered as representing the reference sequence to which the first strands are being compared. The first and second strands are annealed to form precursor polynucleotide duplexes in step 312 that are protected from exonuclease degradation at the 3′ end of the second strand.

Because variations/mutations in the region of interest under study will represent a very small percentage of the polynucleotides in the sample (for example when screening for individuals having rare polymorphisms in a gene of interest), it will be very unlikely for a first strand having a variation/mutation to form a duplex with a second strand having the complementary base variant/mutation. As such, duplexes having mismatched base pairing at the site of a first strand variation/mutation will be heavily favored over duplexes having matched base pairing at the site of a first strand variation/mutation. In other words, it is very unlikely for a first strand having a variation/mutation (a low-frequency occurrence) to anneal with a second strand having the complement of the variation/mutation. This is especially the case in multiplexed samples having polynucleotides derived from tens, to hundreds, to thousands of different individuals, where a single individual (or a small percentage of individuals) has the variation/mutation.

In step 314, the precursor duplexes formed in annealing step 312 are treated with an exonuclease with 3′ exonuclease activity (e.g., Exonuclease III) which removes bases from the first strand until it encounters the first non-cleavable linkage in the first strand (e.g., a phosphorothioate linkage). In general, in the majority of duplexes the first encountered phosphorothioate linkage occurs at a site of a matched base between the first and second strand. However, in a minority of duplexes, the first encountered phosphorothioate linkage is at a site of a base mismatch in the duplex, i.e., at the site of a variation/mutation in the first strand (as compared to the second strand).

The resultant duplexes from step 314 are then processed in a mismatch selection assay 316 to isolate the duplexes in which the 3′ terminal base of the first strand (e.g., the phosphorothioate-linked base) is mismatched with the second strand (e.g., as described above). The first strand of isolated mismatched duplexes is retrieved and processed in steps 318 and 320 to obtain relevant sequence information (described below). For example, the retrieved first strand may be sequenced to obtain a signature sequence and the identity of the mismatched base (as shown in step 320). By “signature sequence” is meant a sequence from a polynucleotide that is of sufficient length to positively identify the exact position of a mismatched base in the first strand (or other base of interest in a polynucleotide). In other words, when analyzing a multiplexed sample containing polynucleotide duplexes from a specific genomic region of interest, a signature sequence obtained from the first strand of an isolated duplex will allow the precise location of the mismatched base to which it is adjacent to be determined. Because the identity of the mismatched base itself will also be determined in the sequence, the location and identity of the precise variation or mutation is obtained. In certain embodiments, the sequence of the MID of the first strand is obtained to identify from which original sample the mutant strand was derived.

Below is provided exemplary descriptions of each of the steps in the workflow shown in FIG. 3. As is noted throughout, the workflow is meant to be exemplary and not limiting, as specific steps shown may be modified or deleted entirely. Also, additional steps not recited herein may be added. Variations to the workflow described herein will generally depend on the desires of the user.

It is noted here that any convenient method for generating, obtaining, or isolating polynucleotide duplexes that find use in mutation screening as described herein can be used (e.g., having a 5′ overhang on the second strand and a mixture of 3′ terminal matched and mismatched bases on the first strand), and thus no limitation in this regard is intended. As such, the description below for generating a sample of polynucleotide duplexes is exemplary and not limiting.

### Exemplary Starting Polynucleotides

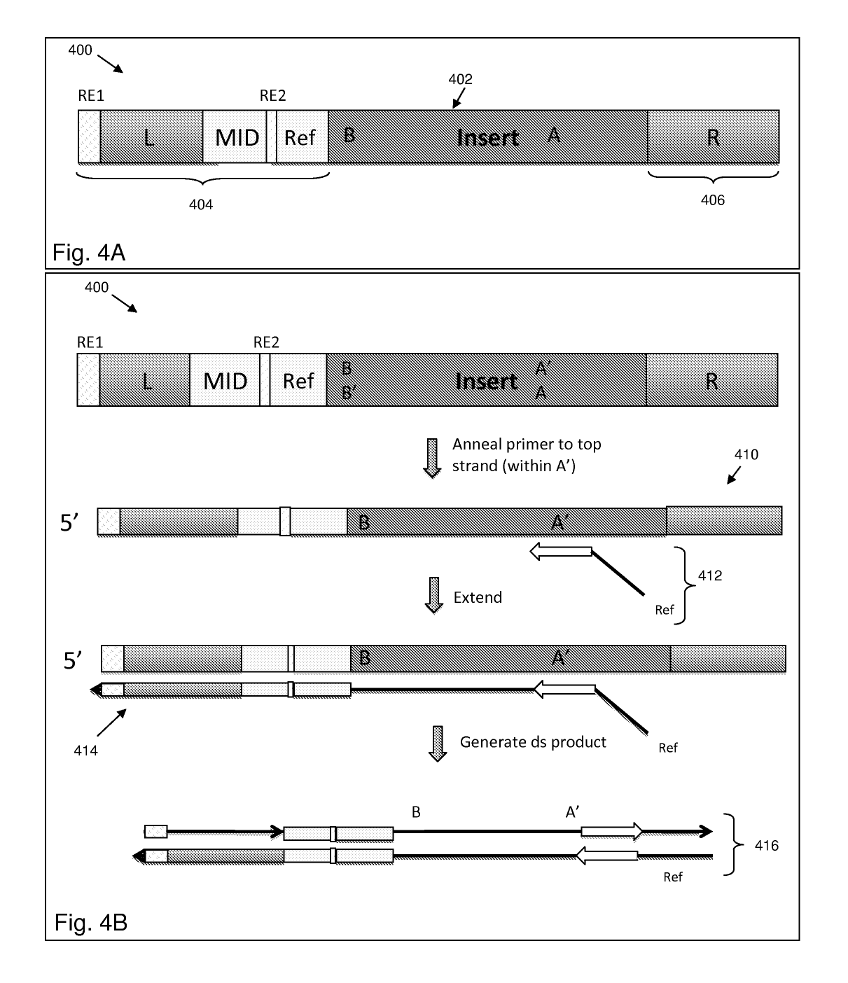

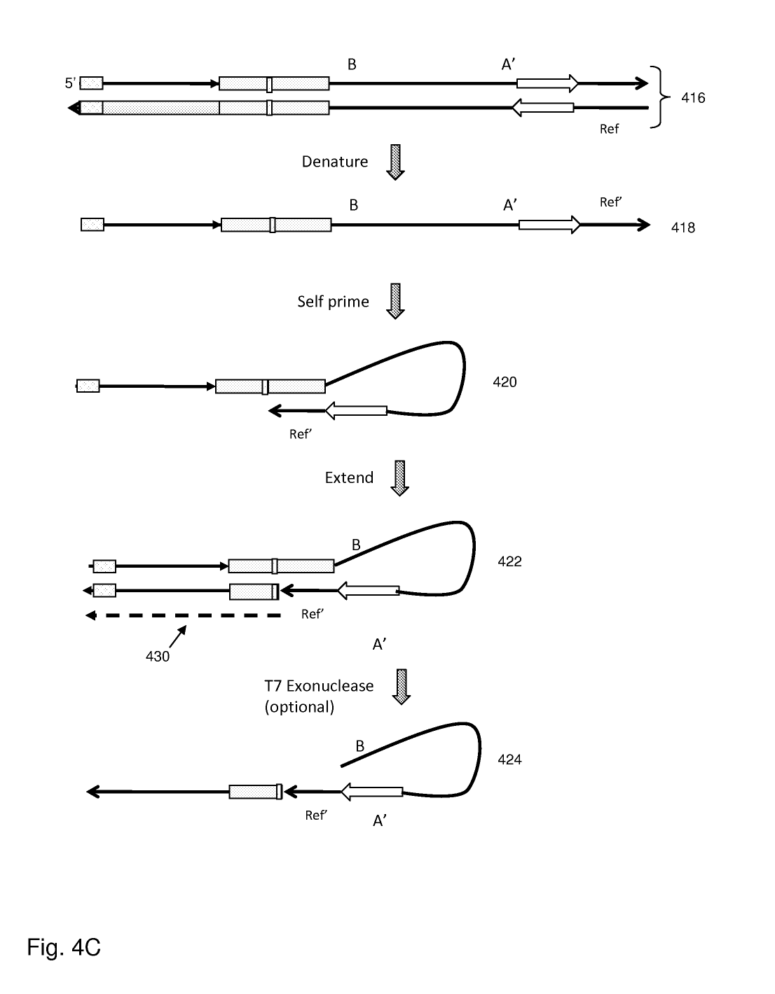

Polynucleotides that find use as starting material for generating polynucleotide duplexes for mutational screening (as described above) can have a variety of structural features. FIG. 4A provides a schematic of an exemplary starting polynucleotide having a variety of different structural components. Again, the number, position and type of structural features present in polynucleotides in the starting polynucleotide sample can vary widely and will be dependent on the desires of the user. As such, a polynucleotide may have all, a subset, one or none of the structural features shown in FIG. 4A.

In FIG. 4A, polynucleotide 400 represents a double-stranded polynucleotide having multiple distinct structural features. Polynucleotide 400 includes a region of interest 402 flanked by two adapter domains 404 and 406 (sometimes referred to as left and right domains, respectively). It is noted here that the polynucleotides in a sample for processing as described herein may all contain the same region of interest (e.g., a region from a single genomic locus) or may be a mixture of polynucleotides having different regions of interest (e.g., regions from multiple different genomic loci). This aspect will be determined by the desires of the user, and as such, no limitation in this regard is intended. Left domain 404 may include any number of different functional sequences that find use in previous or subsequent processes. For example, the left domain 404 in FIG. 4A includes, in a 5′ to 3′ orientation with respect to the top strand of the polynucleotide, a first restriction enzyme recognition site (RE1), a first adapter sequence (L), a multiplex identifier (MID), a second restriction enzyme recognition site (RE2) that is different than RE1, and a reflex sequence (Ref). While not shown in FIG. 4A, additional bases upstream of the RE1 site may be present, and as such, the RE1 site may not be located at the extreme 5′ end of the first strand of the duplex.

In certain embodiments, RE1 and RE2 are unique sites in polynucleotide 400, i.e., they do not appear at any other location in the polynucleotide outside the left domain. The left domain 404 may have any number of different unique restriction enzyme sites (e.g., from 1 to 10 or more) at any of a variety of positions, which will largely depend on subsequent processing steps and/or the desires of the user.

In certain embodiments, the left domain includes first adapter sequence (L) that represents a unique sequence in the left adapter domain of polynucleotide 400 that can be exploited for performing any of a variety of manipulations (in either previous or subsequent process/analysis steps). For example, the L sequence can include a primer binding site for use in sequence analysis (i.e., as a sequencing primer binding site), nucleic acid synthesis reactions (e.g., PCR or linear amplification reactions used to produce copies of the downstream sequence present), or for isolation purposes (e.g., using a capture primer). The L sequence can also include promoter sites, e.g., for RNA polymerase, that can be used to replicate polynucleotide 400.

In certain embodiments, the polynucleotides in the starting sample include a MID. As defined above, a MID is a tag associated with a polynucleotide whose identity (e.g., sequence) can be used to differentiate polynucleotides in a sample. In certain embodiments, the MID on a polynucleotide is used to identify the source from which a polynucleotide is derived. This aspect of the MIDs finds use in applications in which the starting sample is a mixture of polynucleotides derived from different sources, e.g., from different individuals of a population.

While the mutation analyses described herein may be used in any number of different analytical settings, the description below demonstrates that performing mutational screening on multiplexed (or mixed), MID-tagged polynucleotide duplexes is a powerful method for identifying individuals in a population that have nucleic acid sequence variation(s) (or mutations).

In certain embodiments, the polynucleotides in the starting sample have a reflex sequence (Ref) in the left adapter domain 404. The reflex sequence finds use in performing intramolecular rearrangement to place a region of interest in proximity to a functional domain (e.g., a sequencing primer binding site). The use of reflex sequences is described in detail in U.S. provisional application 61/235,595, filed on Aug. 20, 2009 and entitled “Compositions and Methods for Intramolecular Nucleic Acid Rearrangement Using Reflex Sequences”, incorporated herein by reference. Exemplary reflex processes are also described below.

The region of interest (ROI) 402 of the polynucleotides in the starting sample can be any region for which mutational analysis is desired. For example, the region of interest can be a genomic region, a region from an expression product (e.g., from an mRNA), a synthetically produced region, etc. In certain embodiments, the starting sample is a mixture of polynucleotides derived from multiple different sources where the polynucleotides include the same, single region of interest. For example, the polynucleotides in the mixture might each include the same region from a gene of interest (e.g., a specific exon of a gene). In certain other embodiments, the starting sample may be a mixture of polynucleotides from multiple different regions of interest (e.g., regions from multiple different genomic loci). As noted above, the number and identity of the one or more regions of interest in a starting sample will be determined by the desires of the user, and as such, no limitation in this regard is intended. In embodiments in which polynucleotides in the starting sample are from multiple different sources, the polynucleotides can be tagged with a MID corresponding to their source, such that at any point in subsequent analysis or processing steps, determining the identity of the MID will correlate a polynucleotide with its source. It is noted here that in certain embodiments, the starting sample includes polynucleotides from one or more regions of interest derived from a single source.

Any convenient method for isolating polynucleotides from one or more samples having a region (or regions) of interest may be used. For example, one or more species of nucleic acid fragment may be selected from a sample by hybridization to one or more capture moieties (e.g., capture oligonucleotides or capture antibodies, e.g., specific for a transcription factor; etc.). In such embodiments, the sample is contacted to the capture moiety (or moieties) to form target/capture moiety complexes. Unbound polynucleotide fragments are washed away from these capture complexes after which the captured target nucleic acid fragments are eluted. These selected nucleic acids can then be subjected to subsequent processing (e.g., asymmetric tagging, amplification, sorting, etc.). In certain embodiments, the polynucleotides selected have attached adapter(s) (e.g., as shown in FIG. 4A) prior to selection. Exemplary, non-limiting enrichment processes are described in U.S. Patent Application Publication 20060046251; U.S. Pat. No. 6,280,950; and PCT publication WO/2007/057652, all of which are incorporated by reference herein in their entirety.

In certain embodiments, polynucleotides in the starting sample include a second adapter domain 406 (the right domain). As with the left domain 404, the right domain 406 may include any number of functional sequences that find use in previous or subsequent processing steps. In certain embodiments, the right domain includes an adapter sequence (R). Similar to adapter sequence L, adapter sequence R can include a primer binding site that finds use as a site for sequencing, amplification (e.g., PCR or linear amplification reactions), or for isolation purposes (e.g., using a capture primer). In certain embodiments, the R sequence can be used in steps to select polynucleotides having a region of interest (as noted above). For example, the R sequence may include a primer binding site that allows sorting of polynucleotides having a specific sequence proximal to the R sequence. Exemplary sequence specific sorting is described in U.S. provisional patent application 61/180,583, filed on May 22, 2009 and entitled “Sorting Asymmetrically Tagged Nucleic Acids by Selective Primer Extension”, incorporated herein by reference.

Construction of polynucleotides in the starting sample having one or both of a left and right domain may be achieved in any convenient manner. In certain embodiments, polynucleotides have asymmetric adapters (e.g., as shown in FIG. 4A), meaning that the left and right adapter domains (404 and 406 in FIG. 4A) are not identical. Production of polynucleotides having asymmetric adapters may be achieved in any convenient manner. Exemplary asymmetric adapters are described in: U.S. Pat. Nos. 5,712,126 and 6,372,434; U.S. Patent Publications 2007/0128624 and 2007/0172839; and PCT publication WO/2009/032167; all of which are incorporated by reference herein in their entirety. In certain embodiments, the asymmetric adapters employed are those described in U.S. patent application Ser. No. 12/432,080, filed on Apr. 29, 2009, incorporated herein by reference in its entirety.

### Preparation of First (Top) and Second (Bottom) Strand of Polynucleotide Duplexes

Preparation of the desired first and second strands for use in the mutation analyses described herein may be accomplished in any of a variety of ways, which will vary depending on a number of variables, e.g., the structural features of the polynucleotides in the starting sample, prior and subsequent processing steps employed by the user, outcomes desired, etc. As such, production of the first and second strands can include numerous different steps and enzymatic reactions, including polymerase chain reactions, linear amplification reactions, restriction digests, ligation reactions, hybridization reactions, enrichment steps, degradations steps, etc. The specific steps and reactions employed in producing the first and second strands will be generally up to the desires of the user, and as such no limitation in this regard is intended.

Exemplary first and second strand production processes are described below.

In certain embodiments, the polynucleotides for use as templates for producing first and second strands of polynucleotide duplexes are first subjected to a reflex reaction. The reflex process is described in detail in U.S. provisional patent application 61/235,595, filed on Aug. 20, 2009 and entitled “Compositions and Methods for Intramolecular Nucleic Acid Rearrangement Using Reflex Sequences”, incorporated herein by reference. Reflex reactions may be used for many different purposes. For example, in polynucleotide samples having a mixture of polynucleotides which contain both orientations of a region of interest (e.g., with respect to the positions of the left and right domains shown in FIG. 4A), the reflex process will select for the orientation of interest to the user. An exemplary reflex process, using polynucleotides 400 as shown in FIG. 4A, is shown schematically in FIGS. 4B and 4C. It is noted that only the desired orientation of the region of interest is shown in FIGS. 4A and 4B, with the A portion of the region of interest adjacent to the right domain 406 and the B portion of the region of interest adjacent to the left domain 404 (the converse, or non-desired, orientation having the A portion of the region of interest adjacent to the left domain 404 and the B portion of the region of interest adjacent to the right domain 406).

In FIG. 4B, primer 412 having an appended reflex sequence (ref) is annealed to the top strand 410 of the 400. In the embodiment shown in FIG. 4B, the primer binds within the region of interest. The primer annealed polynucleotide is then placed under nucleic acid synthesis conditions to produce a copy 414 of the polynucleotide that has a reflex sequence at its 5′ end. This annealing/synthesis process may be performed under linear amplification conditions.

In certain embodiments, the top strand 410 of polynucleotide 400 is isolated from the bottom strand prior to performing the annealing step, although this is often not necessary. Any convenient method for isolating top strand 410 may be employed. The implementation of a single strand isolation step will generally be based on the desires of the user and can be accomplished using any convenient method.

Polynucleotide 414 is then used as a template for nucleic acid synthesis to produce a double stranded product, e.g., using a primer specific for a primer binding site the left adapter (in the L sequence). In the embodiment shown, the synthesis primer employed in this step includes the RE1 site at its 5′ end, including any upstream bases. The resulting nucleic acid has structure 416 shown in FIG. 4, where the reflex sequence is now located both in the left adapter region (from the original polynucleotide) and on the opposite end.

It is noted here that any convenient method for adding a reflex sequence (or any other domain or adapter) may be used in the practice of the reflex process. For example, the reflex sequence (or its complement) can be added at a particular position by linear amplification, PCR, ligation etc. For double stranded polynucleotides, an adapter can be configured to be ligated to a particular restriction enzyme cut site. Where a single stranded polynucleotide is employed, a double stranded adapter construct that possesses an overhang configured to bind to the end of the single-stranded polynucleotide can be used. For example, in the latter case, the end of a single stranded polynucleotide can be modified to include specific nucleotide bases that are complementary to the overhang in the double stranded adaptor using terminal transferase and specific nucleotides. Again, any convenient method for producing a starting polynucleotide may be employed in practicing the methods of the subject invention.

In FIG. 4C, an exemplary reflex process is shown. In FIG. 4C, polynucleotide 416 is denatured. After denaturation, the reflex sequence and its complement in the top strand 418 are annealed intramolecularly to form structure 420, with the polynucleotide folding back on itself. (As noted above, isolation of the top strand from the bottom strand may be done prior to the intramolecular annealing by any convenient method, if desired.) In this configuration, the 3′ end of the complement of the reflex sequence can serve as a nucleic acid synthesis priming site. Nucleic acid synthesis from this site is then performed producing a complement of the left domain at the 3′ end of the nucleic acid extension (shown in structure 422; extension is indicated by dotted arrow 430).

In certain embodiments, after extension, the first domain and reflex sequence are removed from the 5′ end of the double-stranded region (shown in structure 424). Removal of this region may be accomplished by any convenient method, including, but not limited to, treatment (under appropriate incubation conditions) of polynucleotide structure 422 with T7 exonuclease or by treatment with Lambda exonuclease. In certain embodiments in which Lambda exonuclease is employed, the 5′ end of the polynucleotide is phosphorylated to enhance exonuclease activity of this enzyme (double stranded polynucleotides with a 5′ OH are degraded approximately 20 times slower that those having a 5′ phosphate). In certain other embodiments, the first domain and reflex sequence are not removed from the 5′ end of the double-stranded region (not shown).

The resultant structure 424 shows that a complement of the first domain has been moved intra-molecularly from a position distant from Site A in the region of interest to a position that is separated from Site A by only the complement of the reflex sequence. Moreover, completion of the reflex process produces polynucleotides having the same orientation (in the Watson-Crick sense) of the region of interest.

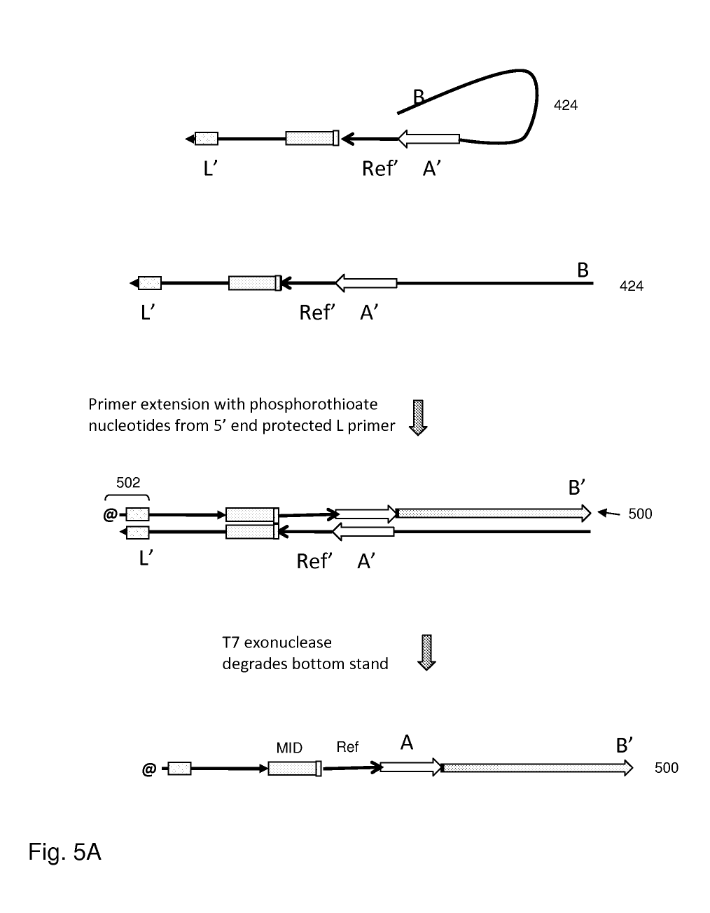

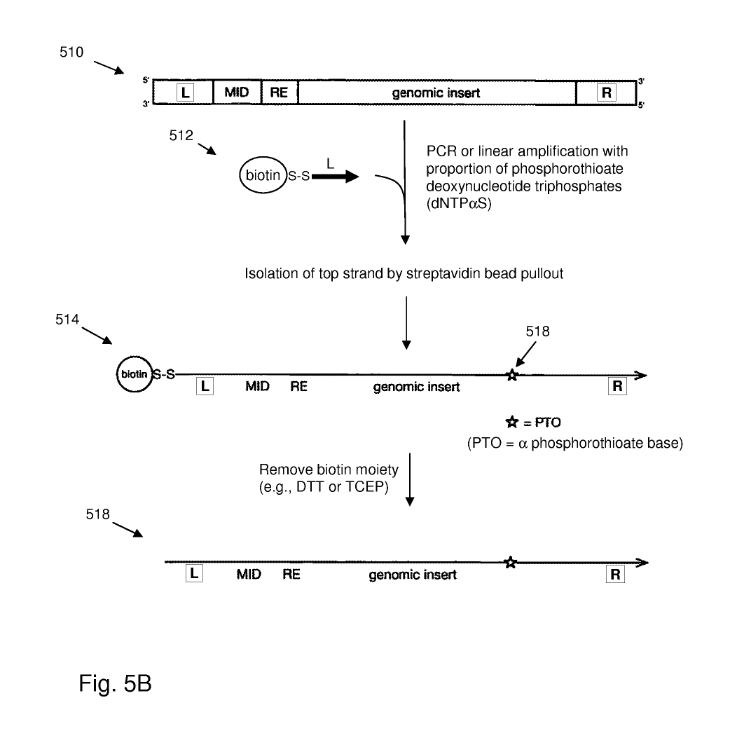

Production of the first strand for producing the polynucleotide duplexes employed in the mutational screening described herein (or their precursor duplexes, as described below) includes generating a copy of the top strand of the polynucleotide 400 (shown in FIG. 4A). In certain embodiments, the bottom strand of polynucleotide 400 (or other equivalent starting polynucleotide) is employed directly as a template strand for producing a copy of the top strand, where in other embodiments, polynucleotide 424 (shown in FIG. 4C and at the top of FIG. 5A) is employed.

As another example, polynucleotide 424 can be used as a template for the production of the first strand, shown schematically in FIG. 5A. In FIG. 5A a synthesis primer specific for a primer binding site in the left adapter region (indicated by region 502), which includes the RE1 site (and any upstream bases) and a site in the L sequence, is annealed to template strand 424. The synthesis primer employed in FIG. 5A includes a protection group that is resistant to 5′ to 3′ exonuclease degradation (e.g., by T7 exonuclease), which is designated by the “@” symbol in region 502. Nucleic acid synthesis is initiated to produce the first strand (shown in structure 500) followed by removal of the template by T7 exonuclease (as noted above, Lambda nuclease may also be employed under appropriate conditions).

It is noted here that binding partner pull-out as detailed in FIG. 5B (described below) may be used to isolate the first strand rather than the nuclease protection/nuclease digestion scheme used in FIG. 5A. Likewise, a nuclease protection/nuclease digestion scheme may be used in the method shown in FIG. 5B (described below) in place of the binding partner pull-out.

In certain embodiments, the nucleic acid synthesis reaction results in a first strand that includes one or more internucleosidic linkages that are resistant to exonuclease degradation (e.g., Exonuclease III (ExoIII), the exonuclease activity of DNA polymerases having proofreading activity, etc.). For example, as shown in FIG. 5A, the first strand synthesis reaction may include one or more spiked in phosphorothioate deoxynucleotide triphosphates (dNTPαS), where by “spiked in” is meant that the reaction mixture includes both standard dNTPs and one or more dNTPαS, generally at lower concentrations than the standard dNTPs. As such, the reaction may include 1, 2, 3 or 4 dNTPαS bases spiked in (e.g., any combination of dATPαS, dCTPαS, dGTPαS, and dTTPαS). This first strand synthesis reaction will produce first strands having randomly positioned phosphorothioate nucleotide linkages therein, which are resistant to cleavage by ExoIII (and the exonuclease activity of any DNA polymerase having proofreading capability that may be employed in subsequent steps). The relative concentrations of the one or more dNTPαSs in the reaction mixture can affect number of phosphorothioate nucleotide linkages (see, e.g., Labeit et al. DNA (1986), vol. 5(2), pp 173-177, incorporated herein by reference).

It is noted here that modified bases other than dNTPαS may be employed that also are resistant to exonuclease activity, any of which may be used. See, for example, Nucleic Acids Research (1999) vol. 27, pp. 1788-1794, which employs alpha-borano phosphate dNTPs (incorporated by reference herein).

As noted above, the polynucleotide sample for use in preparing the first strand of the duplex may be a multiplexed sample, with polynucleotides derived from any number of different sources. In these cases, the polynucleotides will have similar domain structure to one another, with the region of interest in each polynucleotide being derived from one of the different sources. As noted above, there may be one or multiple different regions of interest present in the multiplexed sample, where the one or more regions of interest represent regions of homology between the source samples (e.g., one or more specific genomic regions from each source sample). As such, the one or more regions of interest in polynucleotides derived from a first source can form duplexes with the one or more regions of interest in polynucleotides derived from a second source when the first and second polynucleotides are denatured and annealed under hybridization conditions. It is noted here that the MIDs for polynucleotides derived from different sources will differ, i.e., according to the source from which the polynucleotides are derived, and thus in certain embodiments will not participate in duplex formation. As such, a polynucleotide that contains a region of interest derived from source 1 will have the MID for source 1, a polynucleotide that contains a region of interest derived from source 2 will have the MID for source 2, etc.

Another exemplary structure of double stranded fragments retrieved following region of interest extraction that can be used for first strand production is shown in FIG. 5B (510), where MID is the multiplex identifier sequence, RE is a restriction enzyme recognition site (e.g., GATC for the enzyme Sau3AI), and L and R are regions containing primer binding sites (e.g., for amplification reactions, sequencing and the like). As shown in FIG. 5B, this initial polynucleotide can be employed directly to produce the first duplex strand. In the first step, a linear or PCR amplification step is performed in which the left hand primer 512 for either reaction primes in the L region and includes a capture moiety (in this case, biotin linked to the oligonucleotide via a cleavable linker, such as a disulphide (S—S) bond). Where PCR amplification is used, the second primer of the primer pair anneals within R and does not include the binding moiety (not shown). The reaction mixture contains a proportion of modified phosphorothioate deoxynucleotide triphosphates (dNTPαS), which when incorporated into the DNA strand, confer protection against digestion at those locations by 3′-to-5′ exonucleases such as exonuclease III (as described above for FIG. 5A). After amplification, the first strand is isolated using binding partner pull-out (e.g., streptavidin bead pull-out) producing a population of polynucleotides, exemplified by polynucleotide 514. In the population of polynucleotides, a subset have incorporated one or more phosphorothioate base (PTO; indicated as a star in polynucleotide 514). These PTO bases are incorporated randomly during the amplification process such that in the population of polynucleotides produced, there is at least one polynucleotide that has a PTO at each potential incorporation site. For example, an amplification reaction that includes dATPαS nucleotides in the reaction will produce a population of polynucleotides where for every potential dATP incorporation site, there is at least one polynucleotide in the sample with a dATPαS incorporated at that site (similar to ddNTP incorporation in standard Sanger sequencing reactions). Removal of the binding moiety (e.g., biotin) can be accomplished using a reducing agent (e.g., dithiothreitol (DTT), tris(2-carboxyethyl)phosphine (TCEP), etc.).

In certain embodiments, the first strand (regardless of how it is produced) is quantified before being hybridized to the second strand, the production of which is detailed below.

The second strand of the duplexes can be thought of as a polynucleotide having a reference sequence to which the first strand of the duplex is being compared. In certain embodiments, the reference sequence is called a “wild type” sequence. In this context, the term “wild type” simply refers to the reference sequence for a polynucleotide region of interest; it is not meant to imply that the reference sequence represents a global “wild type” sequence for a region of interest. In certain embodiments, a sample of second strand polynucleotides contains at least 50% or more of polynucleotides that have a “wild type” sequence, including 75% or more, 80% or more, 90% or more, 95% or more, 99% or more, and up to and including 100% of the polynucleotides in the sample.

The second strand of polynucleotide duplexes employed in the subject invention can be produced in any convenient manner. For example, the second strand can be a synthetically produced polynucleotide, a polynucleotide derived from a single source sample (e.g., from a subject that is considered “wild type” for the region of interest), or a polynucleotides derived from a multiplexed sample. As with the first polynucleotide strand, the second polynucleotide may include any number of functional regions/domains, e.g., that include synthesis primer binding sites, unique restriction enzyme sites, etc.

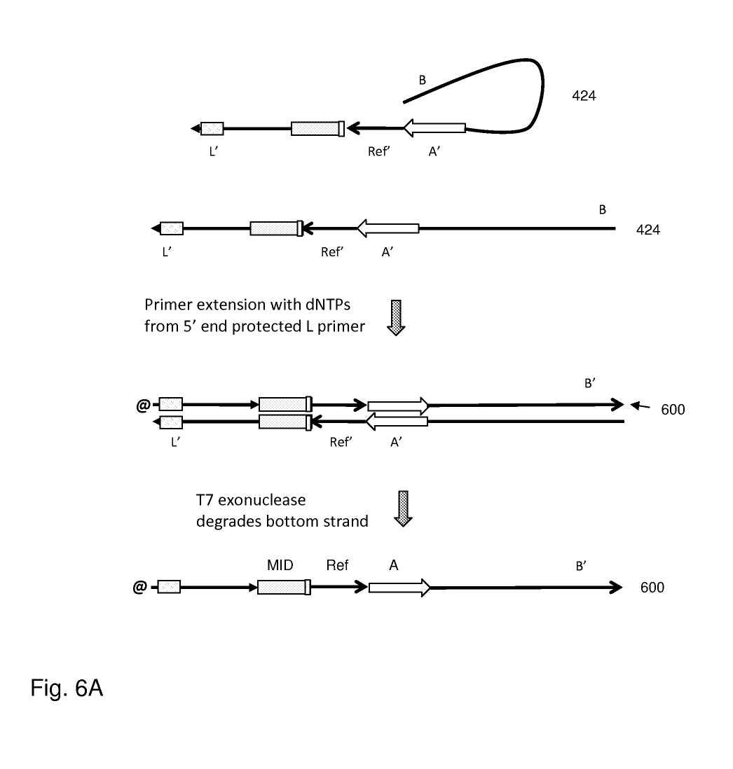

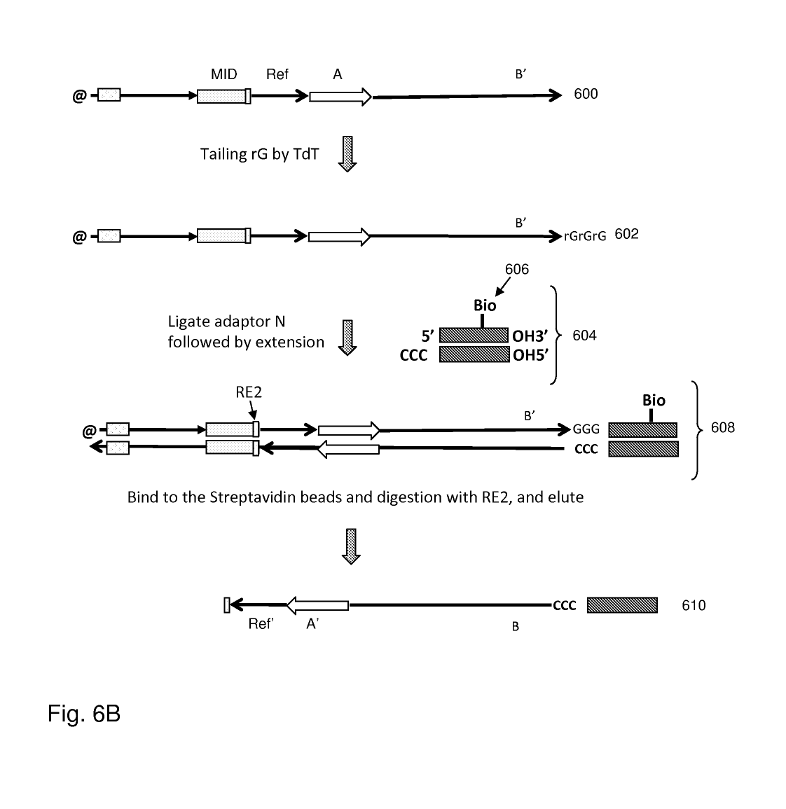

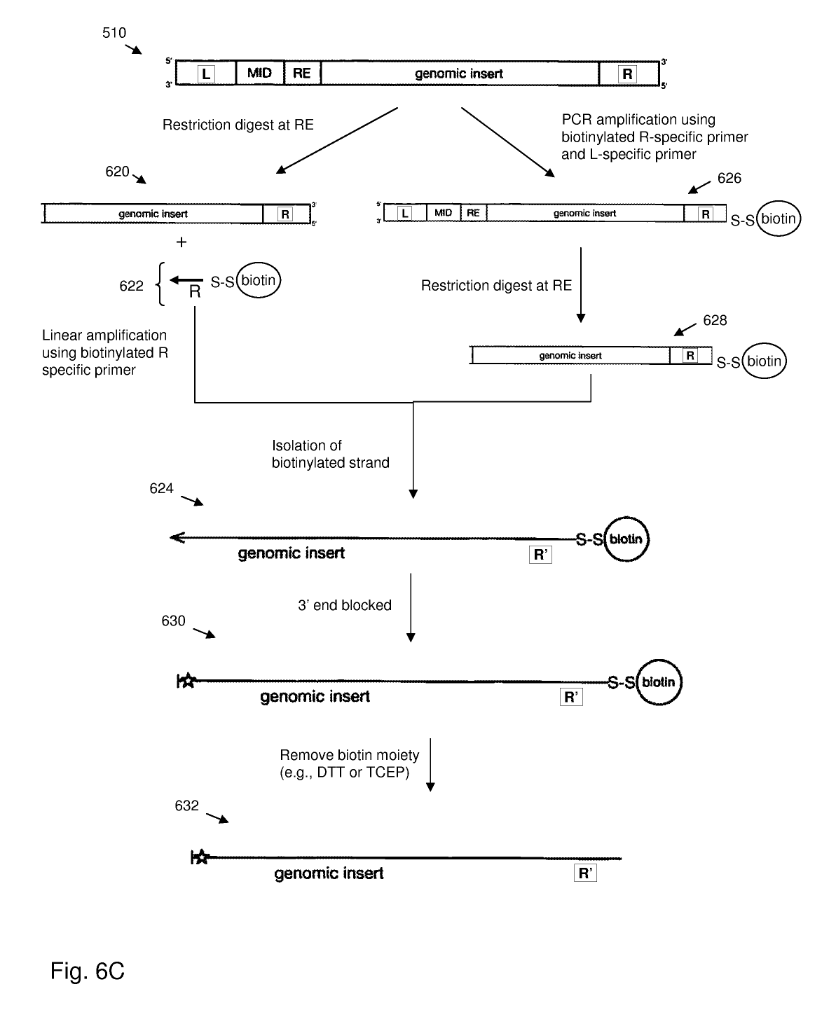

One embodiment for producing second strand polynucleotides is shown schematically in FIGS. 6A and 6B. The process shown therein begins with the same starting material as for production of the first strand of the duplex, i.e., polynucleotide 424. This template is subjected to a primer extension reaction using standard dNTPs and a 5′ protected synthesis primer the binds in the left hand region and includes the RE1 site (protection group denoted by “@” symbol). By “5′ protected” is meant that the synthesis primer is protected from 5′ exonuclease digestion). After synthesis, the template strand is removed by exonuclease treatment (e.g., using T7 exonuclease treatment) to produce polynucleotide 600. The process in FIG. 6A is similar to the initial primer extension reaction for synthesis of the first strand of the duplex, except that normal dNTPs are used and no exonuclease-resistant dNTPs are used (e.g., no α-thio dNTPs, α-borano dNTPs, etc., are used). In FIG. 6B, polynucleotide 600 is contacted to terminal transferase in the presence of ribo-guanosine triphosphate (rGTP) which adds multiple ribo-guanosine nucleotides (ribo-Gs) to its 3′ end to form tailed polynucleotide 602. To this added ribo-G tail, adapter 604 is ligated. Adapter 604 is a duplex containing a 3′ overhang that is complementary to the ribo-G tail of polynucleotide 602 as well as a unique adapter sequence. The adapter also includes a biotin moiety on the top strand 606 which allows for isolation of the strand of interest in subsequent steps (i.e., the strand that is complementary to the first strand produced above). The adapter-ligated polynucleotide is then placed under nucleic acid synthesis conditions to produce double stranded polynucleotide 608 which is then immobilized to a streptavidin-coated substrate. The immobilized double strand polynucleotides are then treated with the restriction enzyme specific for the RE2 site in the left domain to remove the RE1, L sequence and MID sites. The bottom strand of the double stranded polynucleotides are then eluted from the substrate under denaturing conditions, leaving the biotinylated top strands immobilized to the streptavidin-coated substrate. This results in second strands having the structure 610.

As noted above, the steps shown in FIGS. 6A and 6B and described above are merely exemplary, and not meant to be limiting. There are any numbers of variations that can be made to the process for producing second strands having the same or similar structural features as polynucleotide 610 from a multiplexed population. As but one additional example, one could employ a PCR reaction to add the unique domain to the polynucleotides rather than the tailing/adapter ligation strategy shown above.

Another representative embodiment for producing the second strand is shown in FIG. 6C. In this embodiment, the second strand is produced from starting template polynucleotide 510 (same as in FIG. 5B) using either a linear or exponential (PCR) amplification.

If linear amplification is used, the starting polynucleotide 510 is first digested with a suitable restriction enzyme to cleave the fragment at RE removing the MID and the L domain (producing product 620). Linear amplification is then carried out using a 5′-biotinylated primer annealing in the R domain (622), Isolation of the biotinylated polynucleotide product of the linear amplification results in isolated polynucleotide 624 (it is noted here that other binding moieties other than biotin can be used). In certain embodiments, the biotin on the R primer is attached via a cleavable linker, such as a disulphide bond (indicated as S—S on R primer and polynucleotide 624).

In embodiments using PCR amplification, amplification is carried out on polynucleotide 510 with a primer pair that includes a R-specific primer having a biotin moiety (same as primer 622 as used in the linear amplification) with a corresponding L-specific primer without a binding moiety (not shown). After amplification, the product produced (626, with a biotin moiety at the 5′ end of the bottom strand) is cut with the restriction enzyme specific for the RE site to produce polynucleotide 628. Biotinylated polynucleotide strands are then isolated from their corresponding complementary strands using streptavidin bead pull-out (or pull-out using the corresponding binding partner of the binding moiety used), resulting in isolated polynucleotide 624 (similar to the product produced in the linear amplification method, above).

In certain embodiments, a blocking moiety (indicated by a star) is added to the 3′ end of polynucleotide 624 (e.g., a modified nucleotide base, such as a phosphorothioate dideoxynucleotide triphosphate (ddNTPαS)), to produce polynucleotide 630. The blocking moiety confers protection from 3′-to-5′ digestion by exonucleases as well as prevents the strand being extended by nucleotide polymerases in subsequent reactions. An enzyme such as terminal transferase would be suitable for this purpose. (An alternative to this step, which is carried out after first and second strand hybridization, is described below.)

After the blocking step, the binding moiety is removed. For example, as shown in FIG. 6C, polynucleotide 630 can be treated with a reducing agent (such as DTT or TCEP) to cleave the S—S bond and remove the biotin moiety, resulting in polynucleotide 632. This fragment may be quantified prior to hybridization with the first strand (as detailed below).

In certain embodiments, both first and second strand generation may be produced by alternative methods as shown in FIG. 6C. For example, one alternative method is to use a 5′-protected primer in place of the biotinylated primer, where the 5′ protection prevents digestion by a 5′ to 3′ exonuclease (e.g., T7 exonuclease). The desired strand may then be isolated by digestion of non-protected polynucleotides in the reaction sample with a 5′-3′ exonuclease (e.g., T7 exonuclease or lambda exonuclease) instead a performing a streptavidin bead pull-out as shown in FIG. 6C. One example of a 5′ protecting moiety is one or more phosphorothioate linkages at the 5′-end.

The processes described above result in the production of a first strand (or top strand) that includes the MID and a randomly placed phosphorothioate linkage and a second strand (or bottom strand) that lacks the MID and (in certain embodiments) is blocked and protected at the 3′-end.

### Preparation of Polynucleotide Duplexes

As detailed above, the polynucleotide duplexes employed in embodiments of the mutation screening process described herein contain a first polynucleotide strand and a second polynucleotide strand, where the duplexes include a duplex region (region of substantial complementarity) and an overhang region at the 5′ end of the second strand. Any convenient method for producing a sample comprising duplexes that can be screened for sequence variation (as detailed herein) may be employed. As such, any description herein of producing a sample of duplexes to be analyzed is exemplary and not meant to be limiting.

In certain embodiments, formation of polynucleotide duplexes for mutational screening includes treating a precursor polynucleotide duplex (or precursor duplex) with an exonuclease to produce a 5′ overhang region, where the 5′ overhang region, as described above, is present on the 5′ end of the second polynucleotide strand of the duplex.

Precursor duplex formation may be accomplished in any convenient manner. In certain embodiments, the precursor duplexes are generated by hybridizing first and second polynucleotide strands produced separately (e.g., as detailed above). These precursor duplexes are then treated to generate polynucleotide duplexes suitable for mutation/variant screening.

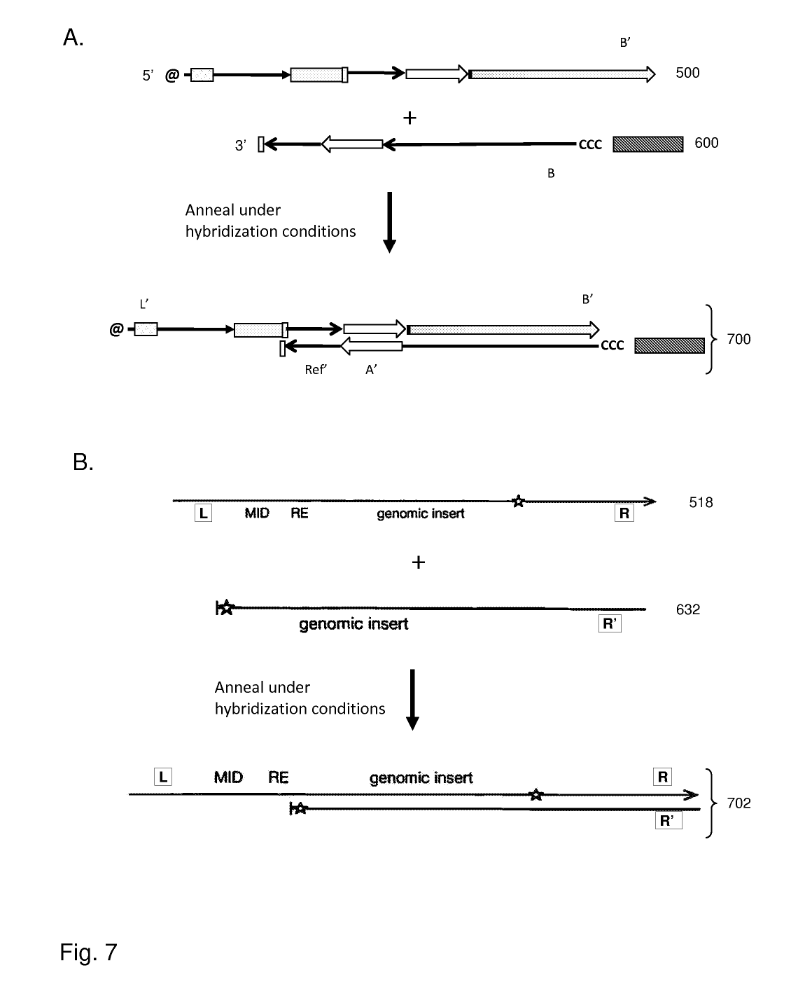

FIGS. 7 to 9 show schematics for an exemplary process for producing duplexes from precursor duplexes, using the first and second strands generated in the previous sections (i.e., polynucleotides 500 and 600).

In panel A of FIG. 7, polynucleotides 500 and 600 are combined, denatured, and then they are annealed under hybridization conditions to form duplex 700. Note that the duplex region of this complex includes the region of interest, the reflex site, and the remaining portion of the RE2 site. Further, as detailed above, the first strand 500 contains one or more phosphorothioate bonds at random positions and the second strand includes a 5′ overhang containing a unique adapter sequence (from adapter 604 in FIG. 6B).

In panel B of FIG. 7, polynucleotides 518 and 632 are combined, denatured, and then annealed under hybridization conditions to form duplex 702. Note that the duplex region of this complex includes the remaining portion of the RE site (not shown in the bottom strand) the genomic insert (or region of interest), and the B domain. Further, as detailed above, the first strand 518 contains one or more phosphorothioate bonds at random positions (star). Also as noted above, if the bottom strand was not subjected to a 3′ blocking step prior to the annealing reaction, a 3′ blocking step may be carried out by using a suitable polymerase and modified nucleotide (such as treatment with Sequenase in the presence of ddNTPαS nucleotides).

In certain embodiments, the bottom strand (632) is in excess in relation to the top strand (518) so that as many of the top strands as possible (the strands being interrogated) are annealed to a bottom strand (the reference strand).

The subsequent processing of the duplexes formed by hybridization of the top and bottom strands for variant/mutant detection will depend on the specific structural features of the duplexes themselves.

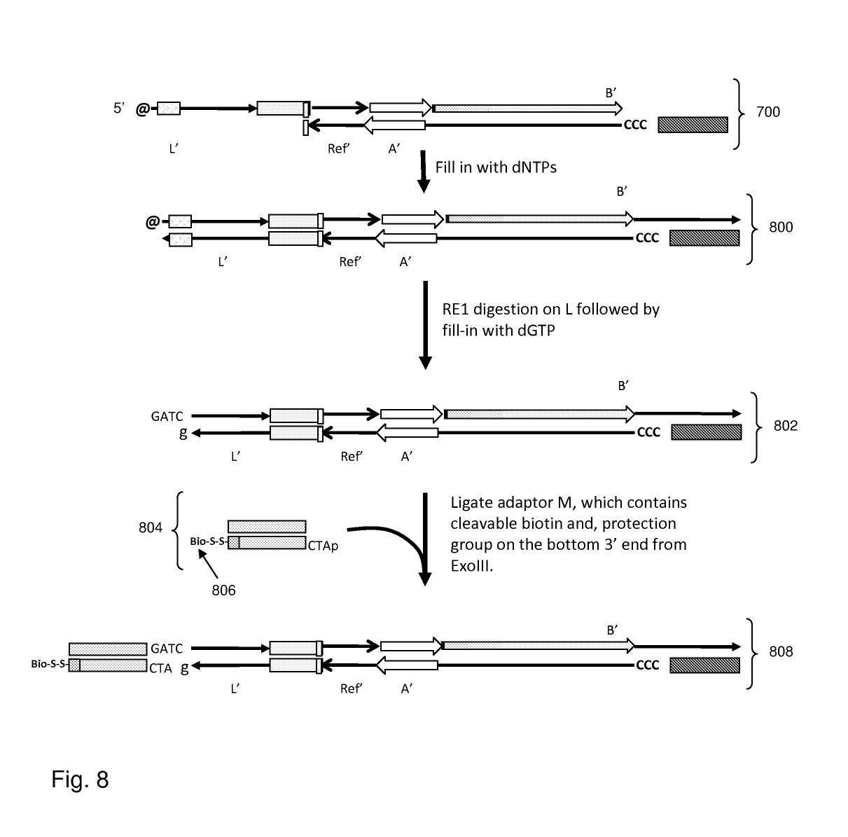

In FIG. 8, duplexes produced as shown in FIG. 7A (having the structure 700) are placed under nucleic acid synthesis conditions to fill in the 5′ overhang regions on both ends of the duplex, generating duplex 800. Filled in duplex 800 is treated with RE1, which in this case leaves a 5′GATC overhang. The cleavage site is partially filled in with dGTP (to prevent unwanted inter-duplex ligation) to produce duplex 802. Adapter 804 having a compatible ligation site with duplex 802 (i.e., having a 5′ ATC overhang) is ligated to the partially filled-in cleavage site. The bottom strand of adapter 804 includes a cleavable biotin moiety 806 and a protection group that blocks exonuclease digestion (e.g., phosphorothioate linkage, LNA, etc., which block ExoIII digestion). Ligation of adapter 806 produces duplex 808. Fully formed duplexes are isolated from non-hybridized first and second strands by contacting the sample to a streptavidin coated solid support, which will bind duplexes having structure 808 via the biotin moiety 806 at the 3′ of the second strand. Isolated duplex 808 is sometimes referred to herein as a “precursor duplex”.

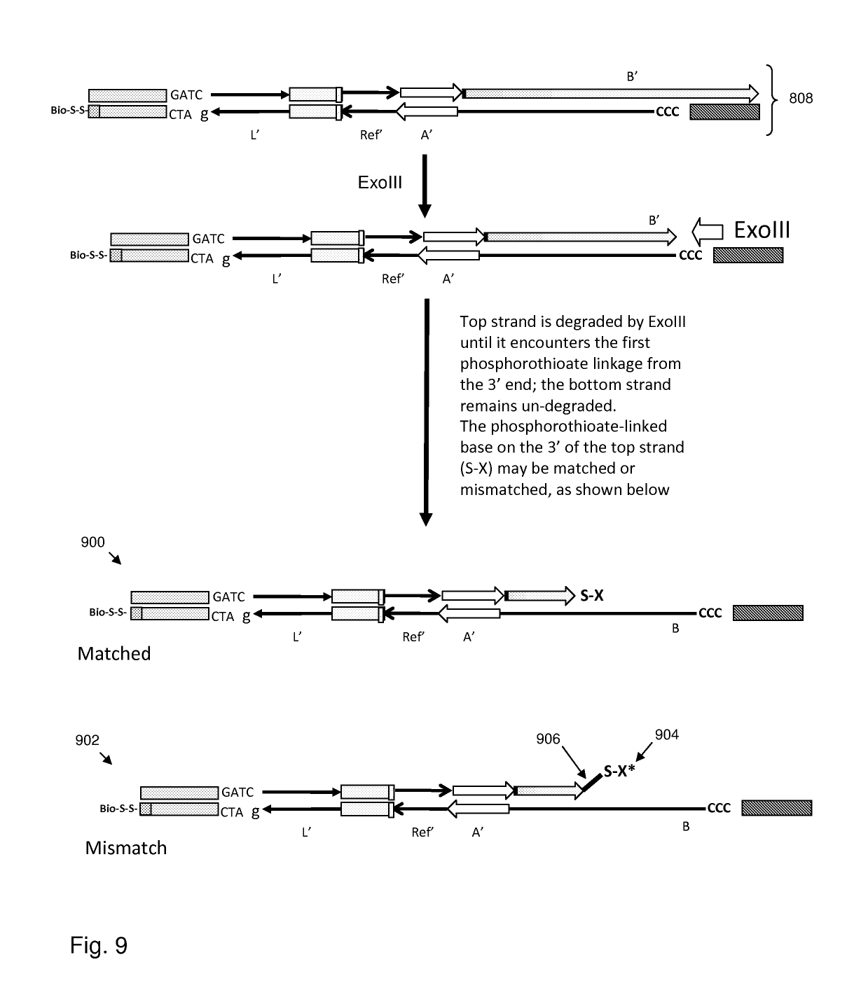

In FIG. 9, precursor duplex 808 is treated with ExoIII, which degrades the first strand in a base-by-base manner from the 3′ end until it reaches the first non-cleavable, or “blocking”, position (e.g., a base having a phosphorothioate bond, denoted as “S—X” in the Figures). The second strand of the precursor duplex is not degraded by the exonuclease due to the protection group at the 3′ end of the second strand. Exonuclease treatment results in the production of a population of polynucleotide duplexes having a 5′ overhang on the second strand, where the population includes duplexes in which the 3′ terminal base of the first strand is either matched with the second strand 900 or mismatched with the second strand 902. In duplexes 900 and 902, the 3′ terminal base is indicated by “S—X”, where the S denotes an α-thiophosphate bond (which was incorporated randomly into the first strand using spiked in dNTPαS, as detailed above) and the X indicates the 3′ terminal nucleotide base. The mismatch in duplex 902 is indicated by an asterisk (*) after the S—X (904) and by the upturn at the 3′ end of the first strand 906.

As such, precursor duplexes having first polynucleotide strands in the which the first blocking base encountered by the exonuclease was incorporated at a position that is complementary to its partner second strand (a “wild type” base) will result in duplex 900, whereas precursor duplexes having first polynucleotide strands in the which the first blocking base encountered by the exonuclease was incorporated at a position that is not complementary to its partner second strand (a variant or mutant base) will result in duplex 902. It is noted here that there may be additional blocking bases present in the first strands of duplexes 900 and 902 upstream of the 3′ terminal blocking base.

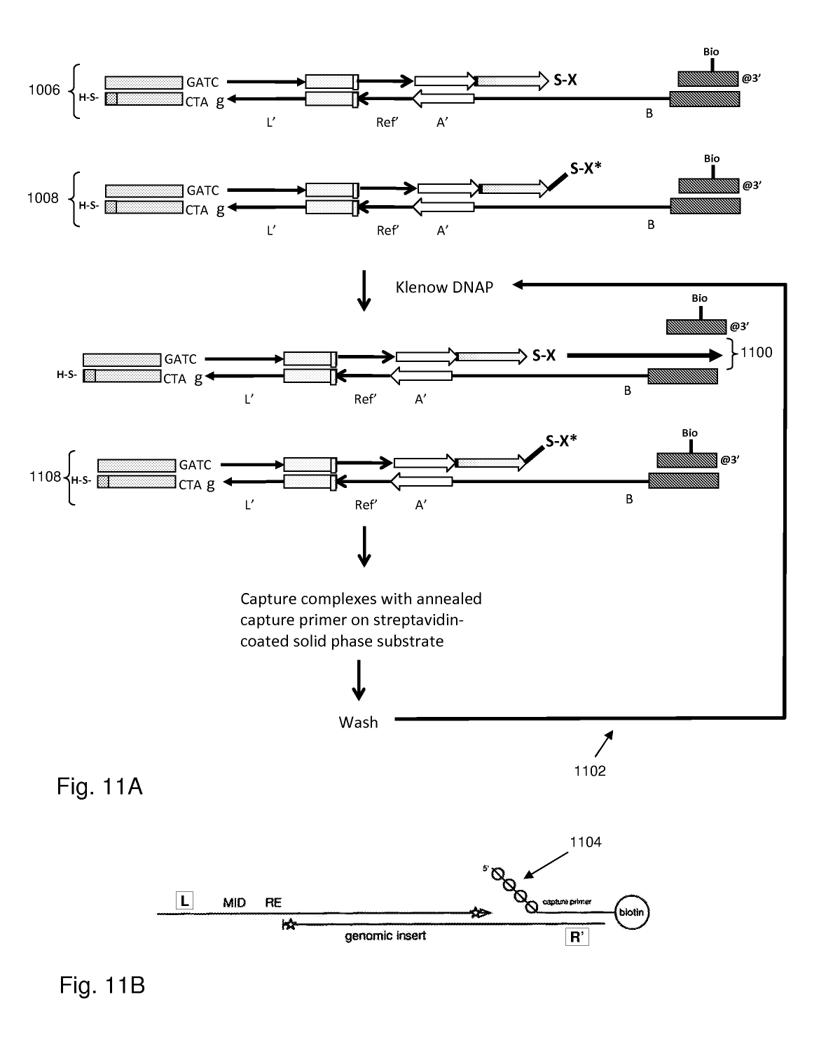

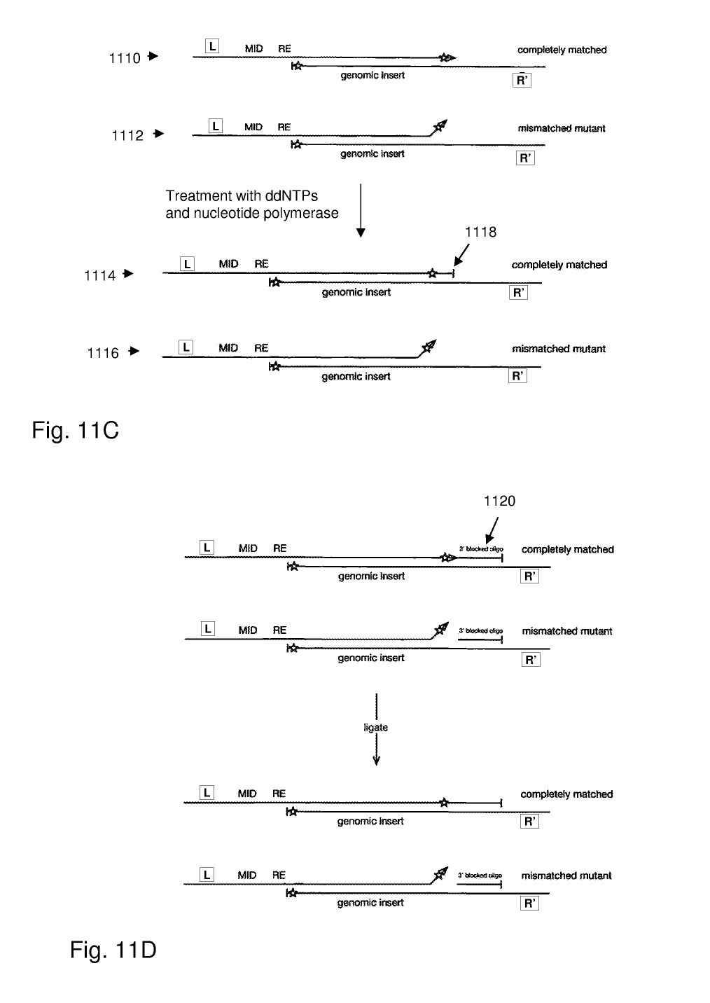

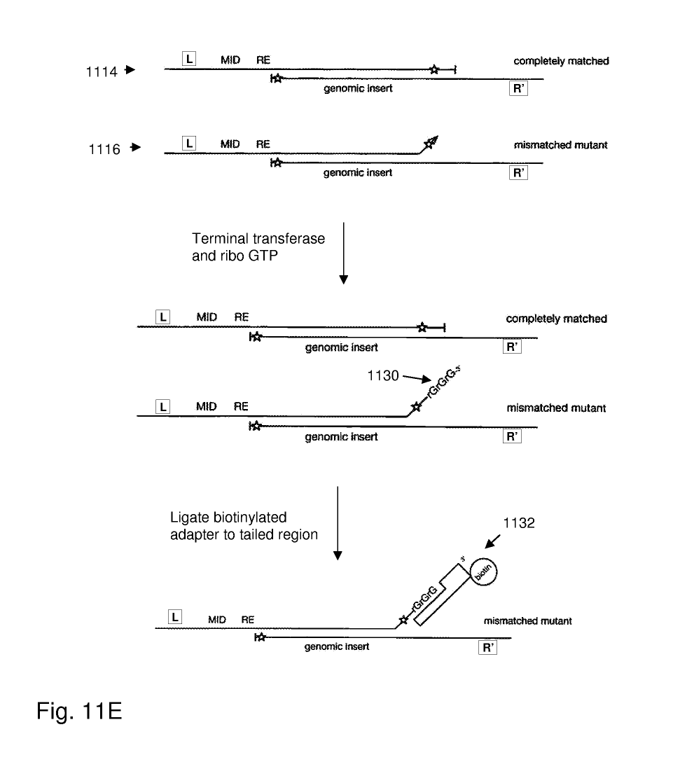

It is noted here that the duplexes shown in FIG. 7B (having structure 702) are themselves precursor duplexes, and thus can be subjected to exonuclease treatment without performing the steps shown in FIG. 8 to add the additional domain (duplexes 702 maintain the R region and thus there is no reason to add an additional domain). Thus, duplex 702 can be treated directly with exonuclease to produce matched and mismatched duplexes similar to duplexes 900 and 902 in FIG. 9 (see duplexes 1110 and 1112 in FIG. 11C).

In certain embodiments, the treatment of precursor duplexes having first strands with one or more randomly-positioned blocking bases with an exonuclease produces a population of duplexes that, when taken together, form a first-strand ladder of duplexes. In the first-strand ladder of duplexes, at least a first duplex has a first strand that is a different length than the first strand of a second duplex in the sample. As such, a first-strand ladder of duplexes may have 10 or more, 100 or more, 1000 or more, or 10,000 or more different sizes of first strands in the duplexes therein. The number of different duplexes in a first-strand ladder of duplexes can be determined by the desires of the user and/or based on the length of the first strand in the precursor duplexes. Therefore, a first-strand ladder of duplexes as described above is akin to the formation of differently sized “ladders” from a sequencing template in standard Sanger sequencing methods, where the ddNTPs spiked into the reaction produces products of differing lengths dependent on at which site the ddNTP was incorporated in the reaction (see, e.g., Labeit et al. DNA (1986), vol. 5(2), pp 173-177, incorporated herein by reference).

### Variant (or Mutation) Screening

Once a population of polynucleotide duplexes is produced which contains one or more polynucleotide duplexes having a matched 3′ terminal nucleotide on the first strand and one or more polynucleotide duplexes having a mismatched 3′ terminal nucleotide on the first strand, mutation screening can be performed.

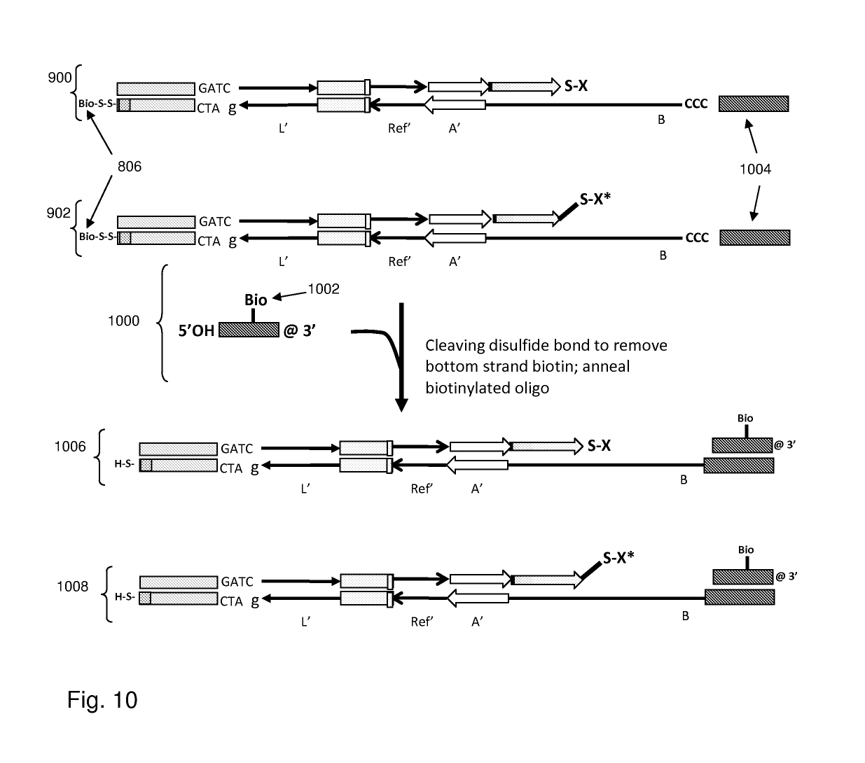

In certain embodiments, mutational screening is accomplished using a strand-displacement strategy. FIGS. 10 and 11A show schematics of exemplary strand-displacement based mutation screening of duplexes 900 and 902.

In FIG. 10, the biotin moiety at the 3′ end of the second strand 806 is cleaved off at the disulfide bond. Following cleavage, a capture primer 1000 specific for the unique region in the 5′ overhang region of duplexes 900 and 902 (i.e., 1004), and which has an attached biotin moiety 1002 and is protected at its 3′ end from exonuclease digestion (denoted by @), is annealed to duplexes 900 and 902. The capture primer annealed complexes 1006 and 1008 are then immobilized to a streptavidin coated solid phase support (as described above) and then placed under nucleic acid synthesis conditions (as shown in FIG. 11A), whereby capture primers downstream of matched 3′ bases in the first strand are displaced 1100. In certain embodiments, the DNA polymerase employed is a proofreading polymerase, e.g., using Klenow DNA polymerase as denoted in FIG. 11A. This releases non-variant strands into the supernatant fraction. In certain embodiments, the capture primer annealed (and immobilized) duplexes are washed and the synthesis reaction is repeated 1102.

As noted above, capture primer displacement may be performed on non-immobilized duplexes followed by isolation of duplexes having annealed capture primers using a solid phase support.

Isolated mismatched duplexes can then be processed as desired by the user.

In certain embodiments, the isolated mismatched duplexes from a first round are subjected to a second exonuclease digestion reaction (a redigestion; e.g., using ExoIII) and a second nucleic acid synthesis reaction (extension reaction). Top strands of the isolated duplexes in which any bases were added in the first nucleic acid synthesis reaction will be digested in a 3′ to 5′ direction up to the first PTO position (which should be the same as in the first round), while duplexes ending in a PTO base will remain the same. As with the first round, the duplexes are subjected to nucleic acid synthesis conditions with a strand displacing polymerase, thereby extending matched duplexes and releasing the capture primer. Mismatched duplexes will maintain their annealed capture primer. This additional digestion/extension reaction can improve the efficiency of mismatch duplex isolation. For example, this second round will displace the capture primer from mismatched duplexes in which the nucleic acid synthesis reaction in the first round did not proceed through the capture primer binding site, thus resulting in a matched duplex retaining the annealed capture primer.

In certain embodiments, the nucleic acid synthesis reaction is performed prior to annealing the capture primer. Extension of the matched duplexes through the capture primer binding site will mask the capture primer binding site, thus preventing annealing of the capture primer. Once the nucleic acid synthesis reaction is complete, the extended matched and unextended mismatched duplexes are contacted to the capture primer under conditions that promote annealing of the capture primer to single stranded capture primer binding sites but not to double stranded capture primer binding sites. After annealing, the mismatched duplexes can be isolated as described above. Because the capture primer is not bound to the duplexes prior to the nucleic acid synthesis step, a non-strand displacing nucleic acid polymerase may be employed. In certain embodiments, after the annealing reaction, another nucleic acid synthesis reaction can be performed (using a strand displacing polymerase) to displace capture primers annealed to matched duplexes that did not extended through the capture primer binding site in the first synthesis reaction.

In certain embodiments, the capture primer is designed to include a 5′-tail that is not complementary to the second strand, and thus does not hybridize (1104 in FIG. 11B). The 5′-tail serves to improve the efficiency of displacement by a strand displacing nucleic acid polymerase during the extension reaction. The circles on 5′-tail 1104 of the capture primer denotes single stranded binding proteins, which may be added to the reaction to help the polymerase displace the capture primer from the second (or template) strand. Note that only the matched duplex is shown in FIG. 11B.

In certain embodiments, mutational screening is accomplished without the use of a strand-displacement step. FIG. 11C provides exemplary mutational screening without strand-displacement. In FIG. 11C, matched and mismatched duplexes (1110 and 1112) are treated with a polymerase (such as Sequenase) and dideoxynucleotides. This results in the addition of a blocking base (i.e., a dideoxynucleotide) in matched top strands (1114 with blocking base 1118), whereas a blocking base is not added to the mismatched fragments due to the inability of the polymerase to extend from the 3′ mismatch (1116).

Alternatively, as shown in FIG. 11D, blocking can be achieved by annealing a blocked oligonucleotide 1120 to the matched and mismatched duplexes on the template strand adjacent to the end of the matched chain and ligate the two together. In certain embodiments, the blocking oligonucleotide 1120 is a mixture of oligonucleotides having random sequence. For example, the blocking oligonucleotide can be a mixture of random octamers, where in certain embodiments, the random octomers have the sequence:

5′ N N I I I I I I-@3′

where N is any nucleotide, I is inosine, and @ is a nucleic acid synthesis blocking moiety. Other random blocking oligonucleotides may also be used.

The schemes shown in FIGS. 11C and 11D result in the matched first (top) strands being blocked at the 3′-end whereas the mismatched fragment will have a single stranded 3′-end that is not blocked, i.e., can be extended by a nucleic acid polymerase under nucleic acid synthesis conditions. This difference can be exploited to isolate mutant strands from the non-mutant strands using any of a variety of methods.

In one example, as shown in FIG. 11E, the mixture of blocked (i.e., matched) and non-blocked (mismatched) duplexes (1114 and 1116 from FIG. 11B) can be treated with terminal transferase and a nucleotide (such as ribo-GTP) to tail the mismatched strand, i.e., the strand capable of supporting nucleic acid synthesis (bases added indicated in 1130). Once the tailing reaction is complete, a biotinylated adaptor (1132) is annealed to the tailed region after which the mismatched fragment can be retrieved, e.g., using a streptavidin bead pull-out reaction. (As indicated above, other binding partner pairs can be used other than biotin/streptavidin). This isolated mutant fragment can be processed as desired by the user (e.g., subjected to subsequent amplification and/or sequencing reactions).

As note above, the differential blocking of the matched versus mismatched duplex first strands can be exploited numerous other ways to isolate the mutant strands from the non-mutant strands.

For example, in certain embodiments, the blocking nucleotides (or blocking oligo) can include an attached binding moiety (e.g., biotin) that can be exploited to remove matched strands from the sample. For example, the hybridized fragments can be treated with a polymerase enzyme (such as Sequenase) and biotinylated dNTPs or ddNTPs. Because of the inability of the mismatched duplexes to be extended by nucleic acid polymerases, only the matched chains will be extended. Removal of these extended strands can be achieved using the binding partner of the binding moiety, e.g., via a streptavidin bead pull-out. The remaining mismatched chains in the sample can then be treated with a polymerase such as terminal transferase followed by adaptor ligation (as described above and shown in FIG. 11E).

### Sequence Analysis

In certain embodiments, the first strand of the isolated polynucleotide duplexes is retrieved and processed to obtain sequence information. Any convenient method for obtaining sequence information from the isolated polynucleotide duplexes can be employed.

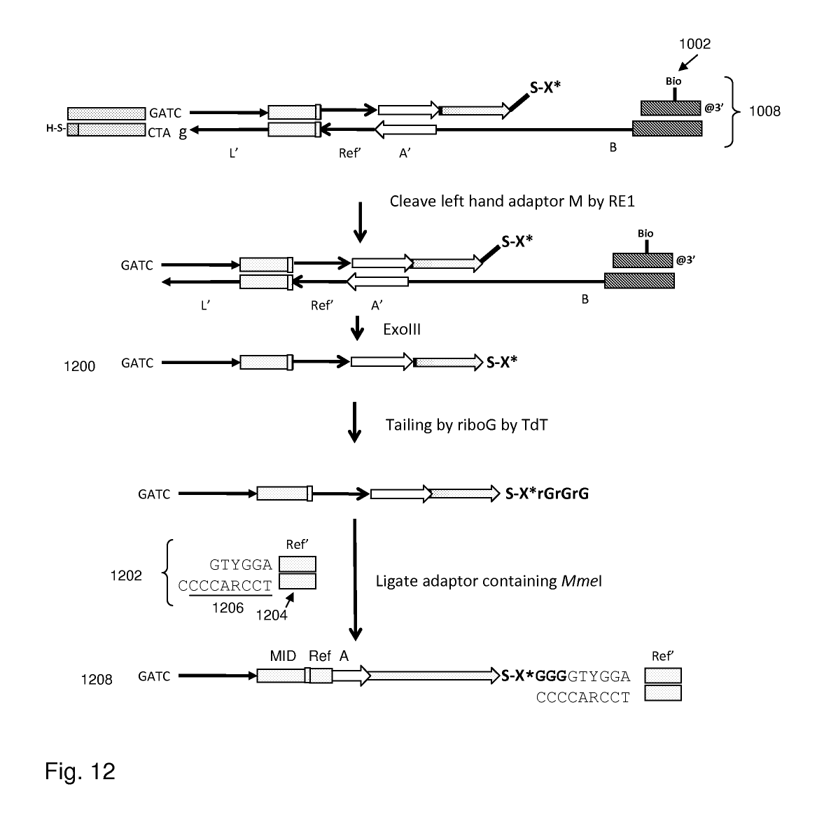

One embodiment for obtaining sequence information from the isolated first strands is shown in FIG. 12.

In FIG. 12, isolated polynucleotide duplex 1008, which is still immobilized to the solid phase support via biotin moiety 1002, is treated with restriction enzyme specific for RE1 in the left domain to remove the exonuclease protection group from the 3′ end of the second strand. After cleavage, the complex is treated with exonuclease III, which will degrade the second strand (but not the capture primer), thus eluting the first strand 1200 from the substrate. First strand 1200 is then tailed by terminal transferase with ribo-Gs (in a reaction described above).

In certain embodiments, the tailing reaction may be performed while the duplexes 1008 are still present on the beads (i.e., before RE1 digestion and exonuclease treatment). Tailing in this way selects against processing unextended matched polynucleotide duplexes because matched 3′ terminal bases are not efficient templates for TdT activity (and thus will not be tailed). Tailing in this manner can be achieved as described above and shown in FIG. 11E.

Duplex adapter 1202 having a compatible ligation site (i.e., 3′ CCC overhang) is attached to the tailed end of the first polynucleotide 1200, where the adapter contains a reflex sequence 1204 and an MmeI restriction enzyme recognition site 1206. MmeI is a Type IIs restriction enzyme which has a cut site at a distance from its recognition site, and thus will cut at a position upstream of the location of the S—X base. Other suitable Type IIs restriction enzymes may be used (e.g., EcoP15I).

It is noted here that other adapter structures containing different bases/base structures can be used. For example, bases in the ligation site of an adapter (e.g., the overhanging bases) may include bases able to pair with more than one type of base (e.g., Hoogsteen bases). The use of Hoogsteen bases for such purposes is well known in the art, and can facilitate obtaining additional bases in the single sequence of a first strand as compared to the use of only Watson-Crick base pairs for a ligation site overhang (e.g., the use of Hoogsteen base pairs can allow one to move the cut site of a Type IIs restriction enzyme further within the region of interest as compared to using an adapter with only Watson-Crick base pairs in the ligation site).

It is further noted that in certain embodiments, the first strand of the duplex may be produced in such a way as to block one or more restriction enzyme sites within the region of interest from being recognized by their cognate restriction enzymes (e.g., the adapter-specific restriction enzyme, e.g., MmeI). For example, the first strand may include, within the region of interest, 5′ methyl C bases which will block MmeI digestion therein. Preparing first strands with restriction enzyme-blocking bases may be achieved in any convenient manner, e.g., the first strand of the duplex may be synthesized in a reaction containing the tri-phosphate precursor of the blocking base (e.g., 5′ methyl-dCTP).

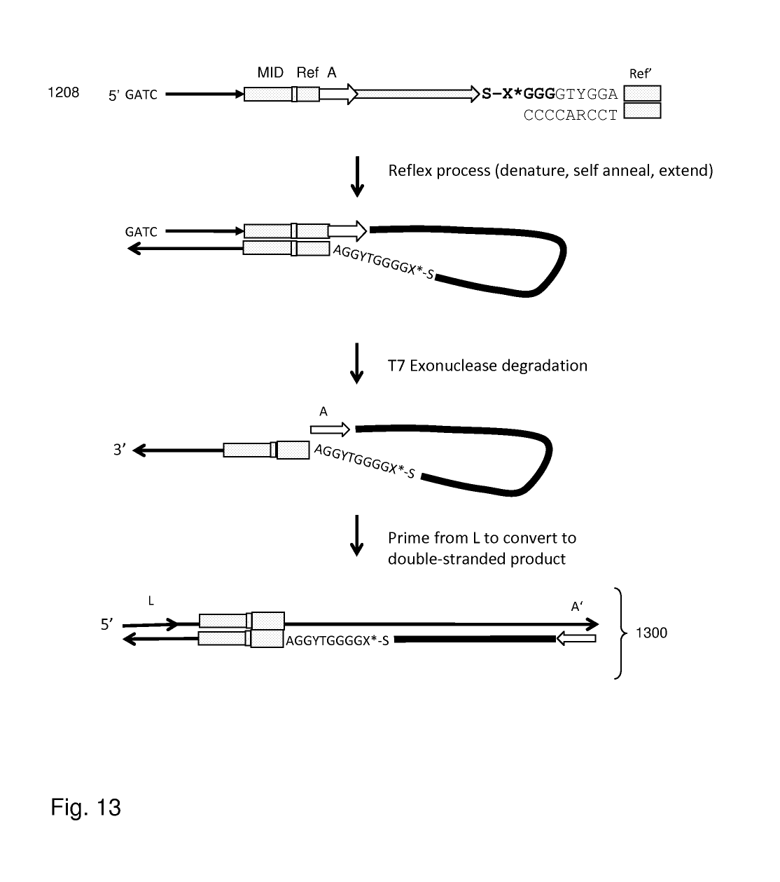

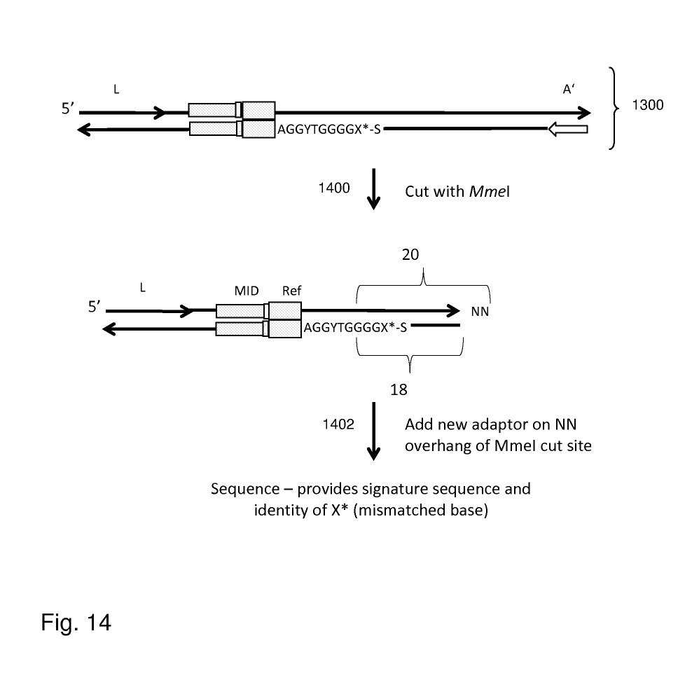

Resultant polynucleotide 1208 can be subjected to a reflex reaction, as schematized in FIG. 13. The resultant single stranded polynucleotide can be converted to double stranded product 1300 using a synthesis primer specific for a sequence in the left domain (e.g., in the L sequence). Cutting this product with MmeI (step 1400 in FIG. 14) and attaching an adapter to this site (e.g., an adapter with a sequencing primer binding site, step 1402) produces a product that can be sequenced to obtain a signature sequence and, at the same time, determine the identity of the mutated or mismatched base. Sequencing may be carried out by any convenient method, including by “next generation” sequencing platforms (e.g., using the Illumina sequencing platform, the Roche 454 sequencing platform, etc.).

As discussed above, a “signature sequence” is a sequence from a polynucleotide that is of sufficient length to positively identify the exact position of a mismatched base in the first strand (or other base of interest in a polynucleotide). In other words, when analyzing a multiplexed sample containing polynucleotide duplexes from a specific genomic region of interest, a signature sequence obtained from the first strand of an isolated duplex will allow the precise location of the mismatched base to which it is adjacent to be determined. Because the identity of the mismatched base itself will also be determine in the sequence, the location and identity of the precise variation or mutation is obtained.

In addition to the signature sequence and identity of the variant base, the sequence of the MID attached to the first strand will also be obtained, thereby allowing the source of the mutant/variant first strand to be identified. In analyzing multiplexed samples, mutations found at different locations in a region of interest can immediately be correlated with their source.

It is noted here that the processing of the isolated duplexes as described herein can be used in any number of different subsequent analyses, and that no limitation in this respect is intended.

### Kits and Systems

Also provided by the subject invention are kits and systems for practicing the subject methods, as described above, such vectors configured to add adapter domains or sequences to nucleic acids of interest and regents for performing any steps in the mutational analysis process described herein (e.g., restriction enzymes, nucleotides, polymerases, primers, exonucleases, etc.). The various components of the kits may be present in separate containers or certain compatible components may be precombined into a single container, as desired.

The subject systems and kits may also include one or more other reagents for preparing or processing a nucleic acid sample according to the subject methods. The reagents may include one or more matrices, solvents, sample preparation reagents, buffers, desalting reagents, enzymatic reagents, denaturing reagents, where calibration standards such as positive and negative controls may be provided as well. As such, the kits may include one or more containers such as vials or bottles, with each container containing a separate component for carrying out a sample processing or preparing step and/or for carrying out one or more steps of a nucleic acid variant isolation assay according to the present invention.

In addition to above-mentioned components, the subject kits typically further include instructions for using the components of the kit to practice the subject methods, e.g., to prepare nucleic acid samples for perform the mutation process according to aspects of the subject methods. The instructions for practicing the subject methods are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g. CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, this means for obtaining the instructions is recorded on a suitable substrate.

In addition to the subject database, programming and instructions, the kits may also include one or more control samples and reagents, e.g., two or more control samples for use in testing the kit.

### Utility

The mutation analysis process described herein provides significant advantages in numerous applications.

For example, the processes herein described allow one to isolate and characterize those regions from a population of samples which differ in sequence from the wild type without sequencing all the regions from all the samples. One thus only sequences the regions immediately adjacent to the variant regions and only in the samples containing the variants. At the same time, using the MID tags, this process identifies the samples which comprise such variant sequences (e.g., which individual harbors the mutation identified and sequenced from the region of interest). Identifying sequence variants and the individuals possessing such variants is useful for relating a specific sequence variation (or variations) to genetic predisposition to a phenotype in the population under study. Such populations occur in scientific research where the aim is to understand the link between phenotype and gene sequence as well as in clinical trials where one wishes to understand links between gene sequence of disease or between gene sequence and efficacy (or toxicity) of potential therapies and drug treatments. Similar applications of course exist in plants, animals and microorganisms.

The above description is provided merely as exemplary of the utility of the subject invention, and is not in any way intended to limit the applicability of the invention to other mutation/variant identification endeavors.

### EXAMPLES

### Example I

This example demonstrates the isolation of polynucleotide duplexes having a mismatched base at the 3′ terminal nucleotide of the first strand from duplexes having a matched base at the 3′ terminal nucleotide of the first strand using strand displacement as described herein.

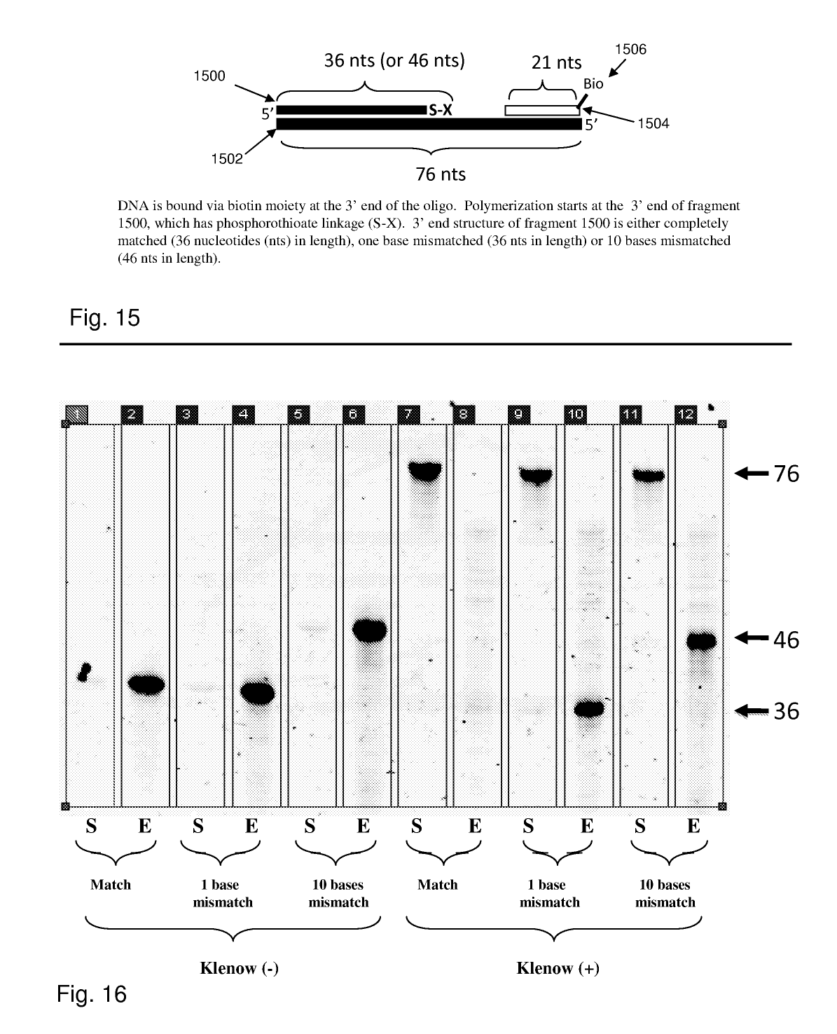

Duplexes employed in this Example are shown schematically in FIG. 15, where the lengths of each of the polynucleotides in the duplex structure are indicated (in nucleotides, “nts”). The polynucleotide duplexes in the population assayed include a first strand 1500 and second strand 1502. The second strands for all duplexes in this Example are 76 bases in length. The first sample contains duplexes with a matched base at the 3′ end of the first strand, the second sample contains duplexes with a single base mismatch at the 3′ end of the first strand 1500, and a third sample contains duplexes with a 10-base mismatch at the 3′ end of the first strand 1500. As indicated in FIG. 15, the first strand of the duplexes in the first and second samples are 36 bases in length whereas the first strand of the duplexes in the third sample is 46 bases in length (due to the additional 10 mismatched bases). The terminal base of all duplexes has an α-thiophosphate linkage, which is resistant to cleavage by a proofreading DNA polymerase.

Capture primer 1504 (21 bases in length, as shown in the FIG. 15) having a biotin moiety 1506 was annealed to the duplexes at a capture primer binding site present in all duplexes. All complexes were then immobilized to streptavidinylated beads.

FIG. 16 shows the fractionation of the first strands of the three different duplexes under nucleic acid synthesis conditions in the absence (lanes 1 to 6) and presence (lanes 7 to 12) of Klenow polymerase. Lanes marked “S” show first strands that were displaced from the beads (i.e., in the supernatant) and lanes marked “E” show first strands remaining on the beads (i.e., analyzed after Elution therefrom).

In the absence of Klenow, the first strands remained exclusively in the bead bound fraction (E lanes 2, 4 and 6). In the presence of Klenow, first strands having matched 3′ terminal nucleotides were extended and displaced into the supernatant (see band of 76 bases in length in lane 7). Importantly, virtually no matched first strands remained on the beads (no significant 36 base pair band in lane 8). Conversely, first strands having a one or ten base mismatch at the 3′ end remained on the beads in the presence of Klenow (see lanes 10 and 12, respectively). It is noted that some first strands from the samples having 1 and 10 base mismatches were eluted (see lanes 9 and 11). However, this is likely due to the fact that during the oligonucleotide synthesis process, when the 3′ phosphorothioate linkage is created, there are two diastereoisomers present, and only one of them blocks the proofreading activity of the Klenow enzyme. The unblocked diastereoisomer is thus cleaved, leaving a perfect hybridization match which can be extended and subsequently displaced by the Klenow polymerase.

This example thus provides experimental evidence that mutant/variant polynucleotides can be isolated using the strand displacement activity of DNA polymerases.

### Example II

This example demonstrates that we can ‘displace’ perfectly matched sequences from a support while retaining the mismatched sequence on the same support.

The sample consists of double-stranded Mbo I digested lambda DNA fragments into which a synthetic duplex with an annealed capture primer has been added (or “spiked-in”). The synthetic construct has a 346 base pair first strand having a terminal alpha-thiophosphate linked base that is annealed to a second strand, where the 3′ terminal 10 bases of the first strand are mismatched with respect to the second strand. The duplex has a 5′ overhang on the second strand to which a biotinylated capture primer is annealed.

There are ˜100 bands of lambda DNA when cut with the restriction enzyme Mbo I. The synthetic duplex was added at a molar concentration about 5× of any one band; hence the mass of the many lambda fragments was much greater than the mass of the synthetic duplex. The lambda fragments were asymmetrically ligation-labeled such that they include a 5′ overhang region on the second strand and an annealed biotinylated capture primer annealed thereto. The 5′ end of the first strand is labeled on all duplexes in the sample (with FAM fluorophore) for subsequent visualization on a denaturing gel.

The spiked lambda DNA duplex mixture was immobilized on streptavidin beads followed by washing to remove unbound complexes. The beads having bound duplexes were then placed under nucleic acid synthesis conditions in the presence and absence of Klenow DNA polymerase.

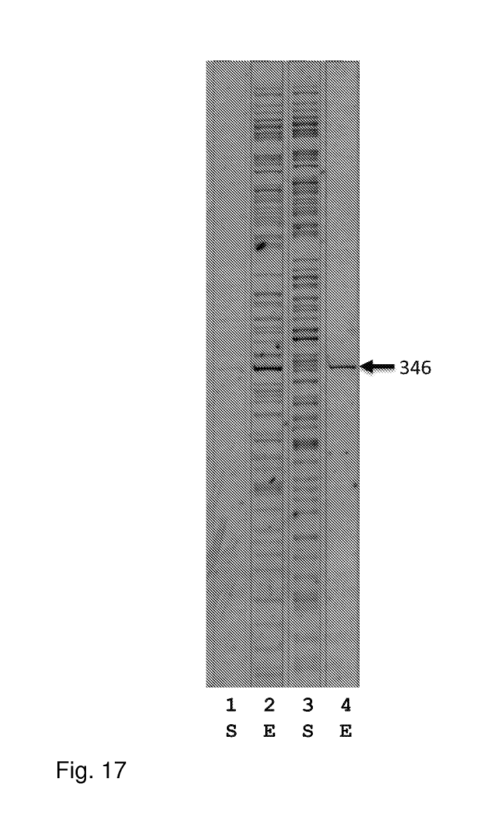

FIG. 17 shows a gel displaying the resultant first strands present in the supernatant (S) and bead (E) fractions under these conditions. Lanes 1 and 2 show first strands in the supernatant and bead fractions, respectively, in the absence of Klenow DNA polymerase. Lane 1 shows that no first strands were displaced without Klenow present; rather, as shown in Lane 2, the first strands remain bound to the beads (any bead-bound first strands are released for analysis by subjecting the beads to denaturing conditions).

However, as shown in Lanes 3 and 4, when the beads were incubated with all components including Klenow DNA polymerase, the matched lambda duplexes (including labeled first strands) were displaced to the supernatant (seen in Lane 3, but not Lane 4). This shows that Klenow synthesis starts at the 3′ end of the first strand of the lambda duplexes and extends the fragment to the end, displacing the duplexes from the beads. Note that bands are shifted to greater lengths relative to Lane 2 because of the presence of the adapter. As shown in Lane 4, only the first strand of the mismatched synthetic construct is present on the beads after the extension/displacement reaction, and thus only this mismatched strand is eluted from the beads in the denaturing conditions.

The presence of the first strand of the synthetic construct in Lane 3 is likely due to the lack of incorporation of a non-cleavable phosphorothioate base at the 3′ end of the 346 nt fragment, which was added enzymatically to the fragment. Any spike-in construct that lacks a non-cleavable thiophosphate at the 3′ terminus of the first strand gets chewed back by the exonuclease proofreading activity of Klenow and then is extended from a preceding matched base, resulting in displacement.

This experiment demonstrates that the displacement process allows displacement from the capture primer (and thus the beads) of duplexes having first strands with matched 3′ terminal bases while duplexes having first strands with mismatched 3′ terminal bases remain annealed to the capture primer, and thus the beads.

### Example III

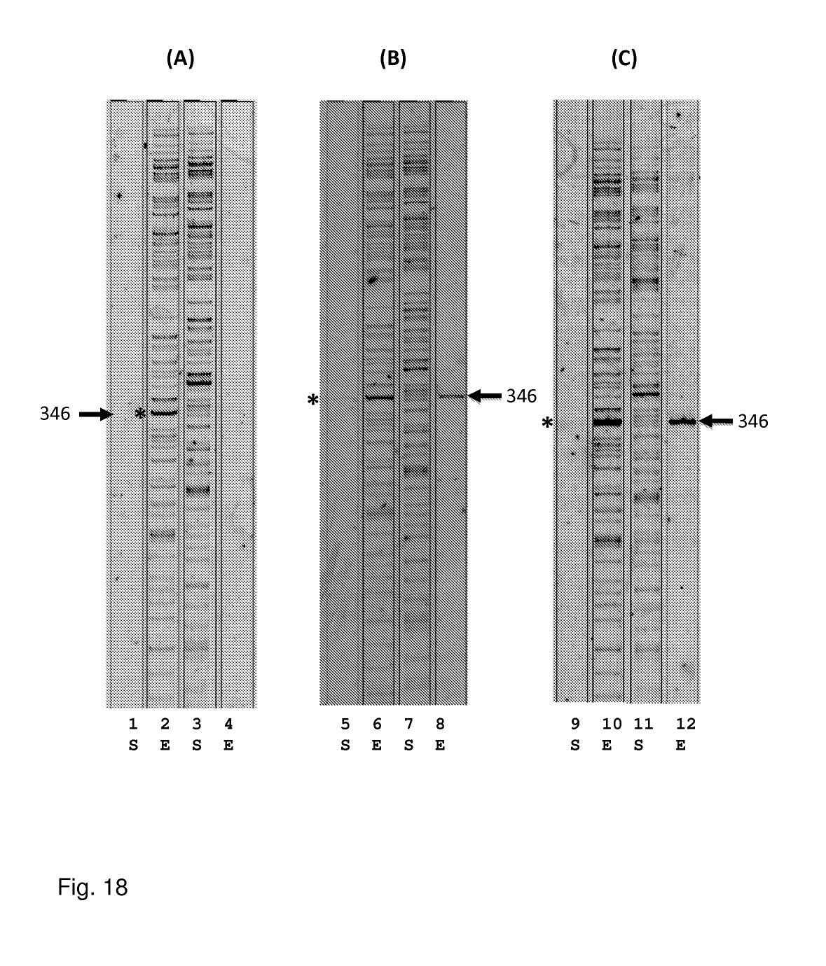

FIG. 18 shows the results of further “spike-in” experiments (e.g., as described in Example II). Three different variations of the spike-in experiment are shown which demonstrate that mismatched duplexes are efficiently isolated by displacement.

Panel (A): Matched spiked in duplex having a 346 bp first strand (position indicated by *). Lanes 1 and 2 are the no Klenow controls. Because no displacement can occur in the absence of Klenow, no displaced first strands were seen in the supernatant (S; lane 1). Rather, all of the first strand fragments remained on the beads, which were detected after placing the beads under denaturing conditions to elute the bound material (see lane 2). Lane 3 is with Klenow and shows that the non-spiked in first strands are displaced and thus are detected in the supernatant (S) fraction. As the spiked-in chain is completely matched at 3′ end, it also is displaced from the capture primer and present in the S fraction along with the rest of the matched duplexes. Because all duplexes were matched duplexes, and thus were displaced from the beads to the S fraction, no duplexes are present in the eluant (E) fraction, i.e., after the displacement reaction, removal of the S fraction, and subsequent elution of duplexes left on the beads (lane 4).

Panel (B): Mismatched 3′ spike in duplex having a 346 bp first strand (position indicated by *). Lanes 5 and 6 are the no Klenow controls. No displacement occurs (lane 5) and all the fragments are left on the bead and then are seen when beads are denatured and the bound material is eluted (lane 6; E). Lane 7 is with Klenow and shows that bands are displaced to the supernatant fraction (S). Due to 3′ first strand mismatch on the spiked-in duplex, Klenow failed to extend and displace the capture primer, leaving the spiked-in duplex on the beads, which was eluted and observed on the gel (see lane 8, E).

Panel (C): Same mismatched spike in duplex as (B) (position indicated by *) except that the spike-in sample was subjected to denaturing conditions followed by hybridization conditions (i.e., the duplexes were denatured and re-annealed) prior to the displacement reaction. Lanes 9 and 10 are the no Klenow controls. No displacement occurs (lane 9) and all the fragments are left on the bead and then are seen when beads are denatured and the bound material is eluted (lane 10; E). Results minor those in Panel (B) (see especially lanes 11 and 12), which demonstrates that the annealing reaction forms duplexes that are suitable for selective displacement reaction.

### Example IV

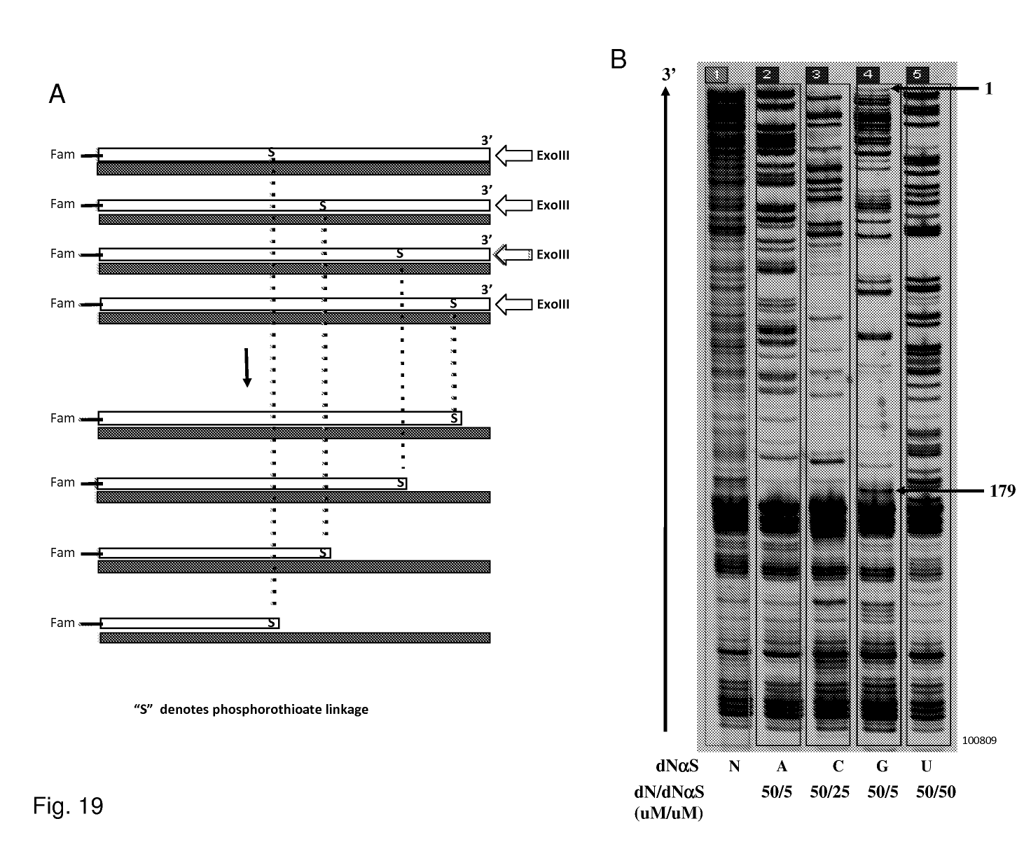

FIG. 19 shows the formation of ladders of first strands by dNTPαS incorporation. Panel A shows exemplary duplex polynucleotides having randomly positioned thio-phosphate linkages, indicated by “S” (top 4 duplexes). Treatment of these duplexes with ExoIII produces a ladder of first strands, each terminating at the randomly positioned thio-phosphate linked base.

Panel B shows an electropherogram of a denaturing 5% polyacrylamide gel displaying the ladders of polynucleotides as schematized in Panel A. The total length of the template used for the experiment in Panel B is 361 bp. A Fam-labeled fluorescent primer was annealed to the template strand and extended in the presence of distinct ratios of standard bases/alpha-thiophosphate bases as follows (ratio numbers indicate micromolar (μM) concentrations; as noted in FIG. 19B): dATP/dATPαS=50/5, dCTP/dCTPαS=50/25, dGTP/dGTPαS=50/5 and dTTP/dUTPαS=50/50. It is noted that the 3′ end of the template strand is not protected from ExoIII digestion, and thus Exo III degradation is not terminated base specifically below base 179 from the 3′ end of the extended strand (indicated on gel). Lane 1 shows the degradation pattern of polynucleotides produced in reactions containing all four phosphorothioate dNTPs at the indicated ratios. As can be seen, this reaction produced a ladder of polynucleotides each terminated at a position of dNTPαS incorporation. Lanes 2 to 5 show degradation patterns of polynucleotides produced in extension reactions containing a single one of dATPαS (Lane 2), dCTPαS (Lane 3), dGTPαS (Lane 4) or dUTPαS (Lane 5). The Ladder patterns in Lanes 2 to 5, when combined together, are matched to the template sequence above base 179 in Lane 1, which indicates that Exo III degradation is terminated base specifically in these reactions.

### Example V

This example describes the results of experiments drawn to aspects of identifying a mutation by combining exonuclease III degradation and DNA polymerase polymerization.

FIG. 20 shows steps of an exemplary base by base mutation screening procedure according to aspects of the present invention. Step I shows preparation of the primer strand (top) and the reference strand (bottom). The primer strand contains randomly placed phosphorothioate linkages while the 5′ end of the reference strand is biotinylated (denoted by B) and the 3′ end contains several consecutive phosphorothioate linkages (denoted by S). The preparation of single stranded DNA for hybridization may be similar to the procedures shown in FIG. 6C, described in detail above. For example, top primer strand preparation can be accomplished by performing PCR in the presence of appropriate concentration of phosphorothioate dNTPs and biotinylated reverse primer. This amplicon can be bound to Streptavidin beads and the top strand eluted. For reference strand preparation, PCR in the presence of normal dNTPs with a biotinylated reverse primer may be performed followed by digestion of the amplicon with an appropriate restriction enzyme to remove any undesired adapter sequences (e.g., the adaptor containing the MID). Phosphorothioate linkages can then be incorporated to protect the 3′ end from exonuclease digestion. Exonuclease III treatment is performed to remove the top strand. This end product can then be bound to Streptavidin beads in order to remove any residual un-degraded top strand (e.g., in an alkaline condition). Bound single stranded DNA to Streptavidin beads can then be retrieved in a mild heating condition.

In step II, the primer (top) and template (bottom) strands are annealed. In the embodiment shown, the 5′ end of the bottom strand has a long single stranded region that can be used in subsequent process steps to incorporate biotinylated nucleotides in the top strand (described below).

In step III, exonuclease III digestion generates ladders of the top strand (denoted by dotted line; this process is described in detail above). The bottom strand is not degraded by exonuclease III in this step because of the consecutive phosphorothioate linkages at the 3′ end (denoted by S).

In step IV, the partially double stranded ladders produced in step III are bound to Streptavidin beads via biotin moiety conjugated at the 5′ end of the bottom strand.

In subsequent steps of the process, biotinylated nucleotides (e.g., dATP) are incorporated on the strands attached to the Streptavidin beads followed by removal of the biotinylated strands with new Streptavidin beads.

To accomplish this, the un-occupied Streptavidin sites on the beads are first blocked by the addition of excess free biotin (denoted by B). At this stage (i.e., after step V in FIG. 20), there are two kinds of ladders bound to the Streptavidin beads: 3′ end matched ladders (denoted by dotted line) and 3′ end mismatched ladders (dented by solid line with a mismatched 3′ terminal base X). Step VI differentiates these ladders using DNA polymerization. Specifically, the ladders attached to the beads are placed under nucleotide polymerizing conditions in the presence of biotinylated nucleotides. Under these conditions, ladders having matched 3′ ends are elongated, thus incorporating biotin moieties. However, ladders having mismatched 3′ ends are not elongated, and thus do not incorporate biotin moieties. In this reaction, the 3′ end of the bottom strand is also extended, and thus is biotinylated. Biotin incorporated region is denoted by the white arrow indicated B inside. All polynucleotide strands that have incorporated biotin, i.e., those having newly synthesized regions, are captured by fresh Streptavidin beads.

In step VII, the bead/ladder complexes from step VI are re-suspended in an alkaline solution to elute all non-biotinylated DNA, which in this case represents DNA having a 3′ mismatched end (the solid DNA strands with the mismatched 3′ terminal base X).

In step VII, the eluted DNA is subjected to a tailing reaction to provide a binding site for an amplification primer, e.g., by treatment with terminal nucleotidyl transferase under the appropriate conditions for nucleotide addition (e.g., with dATP to add a poly A tail). The eluted DNA may be concentrated/washed prior to performing the tailing reaction (e.g., by ethanol precipitation, column purification, etc.).

In step IX, this tailed DNA is amplified by a proofreading DNAP with the forward primer and a reverse primer specific for the tailed region (e.g., poly T reverse primer). In the example shown, the reverse primer includes a poly T region followed by an A, C or G nucleotide at the 3′ terminus (denoted in IUPAC notation as “V”; see Table 1 above). This primer can hybridize and prime nucleic acid synthesis with any polynucleotide having a 3′ poly A-X sequence (where X is any base).

The exemplary process shown in FIG. 20 for isolating variant strands is based on two biochemical phenomena: (1) phosphorothioate linkage resistance to exonuclease III digestion; and (2) the ability of disrupted mismatched structure at (or around) the catalytic site of DNA polymerase to stall polymerization initiation.

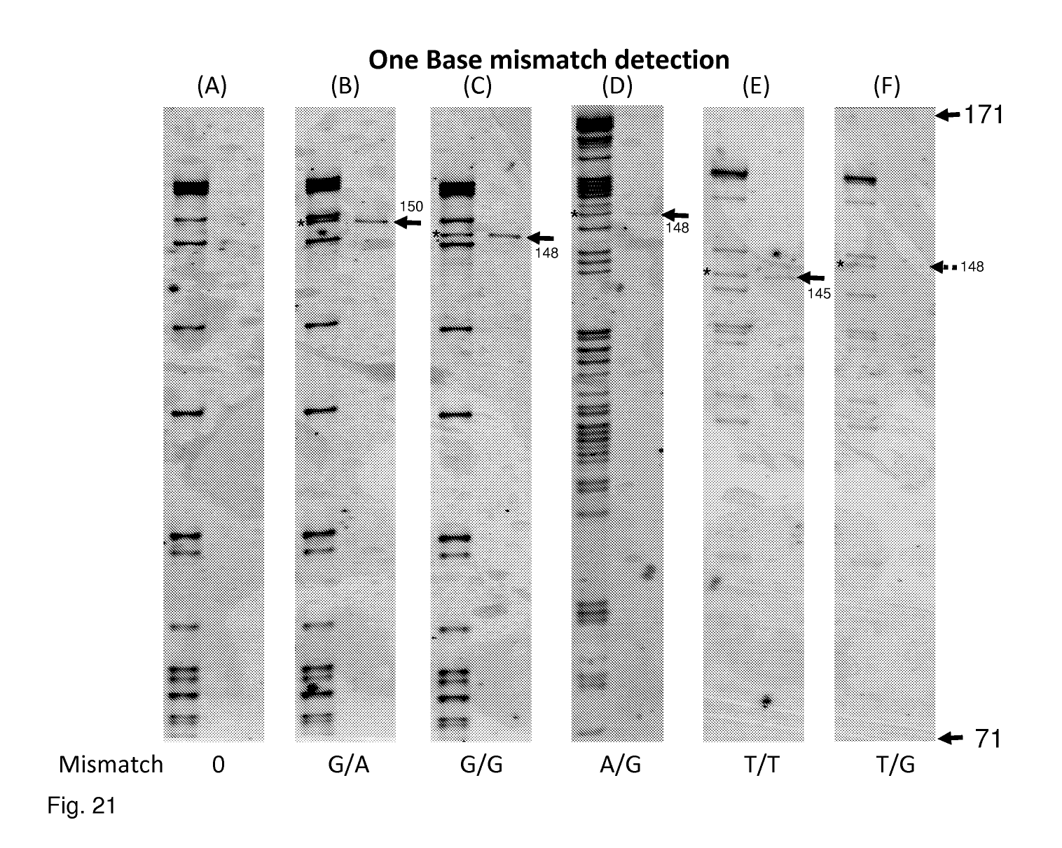

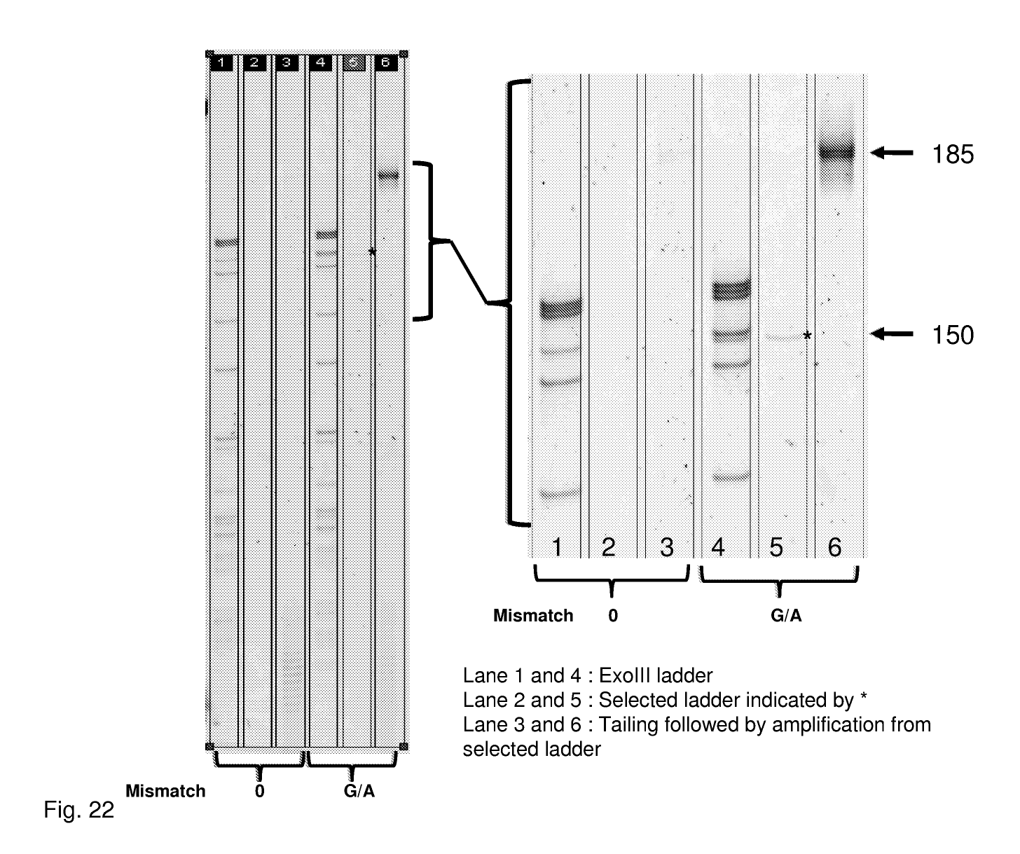

FIG. 21 shows experiments for detecting a single internal base mismatch. Exonuclease III generated ladders and selection of the ladder containing 3′ end mismatch are shown in each panel. The sizes of the ladders shown on the gel are in the range of 71 to 171 nucleotides (nt) in length. The top strand (primer strand) is fluorescently labelled at the 5′ end and contains randomly incorporated phosphorothioate linkages. The bottom (or reference) strand is conjugated to biotin moiety at the 5′ end and includes several consecutive phosphorothioate linkages at the 3′ end to block exonuclease III digestion. The top strand in each experiment is annealed to a common bottom reference strand. The top primer strand in each experiment includes a known mutation as compared to the “wild type” sequence (i.e., a sequence complementary to the bottom strand), and is indicated below each panel. In each panel, the ladder patterns before selection and after selection are shown in the left and right lanes, respectively. After selection, only the known 3′ end mismatched chain should be revealed (indicated by “*”). Panel A is a negative control for a G ladder (i.e., a ladder made with randomly placed α-phosphorothioate G bases) generated from perfectly matched top and bottom strand (no mismatched bases). In panel B, a G/A mismatch from a G ladder is selected. In panel C, a G/G mismatch from G ladder is selected. In panel D, an A/G mismatch from an A ladder (i.e., a ladder made with randomly placed α-phosphorothioate A bases) is selected. In panel E, a T/T mismatch from T ladder (i.e., a ladder made with randomly placed α-phosphorothioate T bases) is selected. In panel F, the ladder contained a T/G mismatch from T ladder. However, the T/G mismatch was not detected (the expected position is indicated by dotted arrow).

The results here demonstrate the ability to select the ladder containing the 3′ base mismatch apart from the T/G mismatch. All fully matched ladders were eliminated. The above result theoretically allows us to detect 8 different one base mutations out of 12 mutations if we can scan on both Watson and Crick strand. Detectable mutations are transversions not transitions. Modifications to the mutation detection process that can detect all mutations are described below.

FIG. 22 shows an experiment for selection and subsequent amplification of a polynucleotide having a G/A mismatch. G ladders were generated by exonuclease III digestion from an amplicon amplified from lambda DNA that was either perfectly matched (lane 1) or contained that contained a known G/A mismatch (lane 4). After ladder generation, nucleotide polymerization was performed in the presence of biotinylated dATP to identify the ladder having the 3′ G/A mismatched chain (denoted by “*” in lane 5). As is shown in the figure, all ladder members having perfectly matched 3′ ends are successfully removed after selection (lane 2 and 5). The G/A mismatched species is clearly seen in lane 5. The selected samples from both experiments (i.e., those shown in lanes 2 and 5) were subjected to a dATP tailing reaction with terminal deoxynucleotidyl transferase. The tailing reactions were PCR amplified with a proof reading DNA polymerase (Pfu DNAP) using common forward primer and 3′ phosphorothioated VT34 poly T primer as a reverse primer (5′-TT . . . T*V-3′, where “*” indicates phosphorothioate linkage; and V is a variable nucleotide base). Only the selected chain at 150 nt in length (lane 5) was amplified and observed at the expected position at 185 nt (lane 6). As expected, the tailing/amplification process from the sample shown in lane 2 did not show any significant signals, as it did not have a selected mismatched species (lane 3).

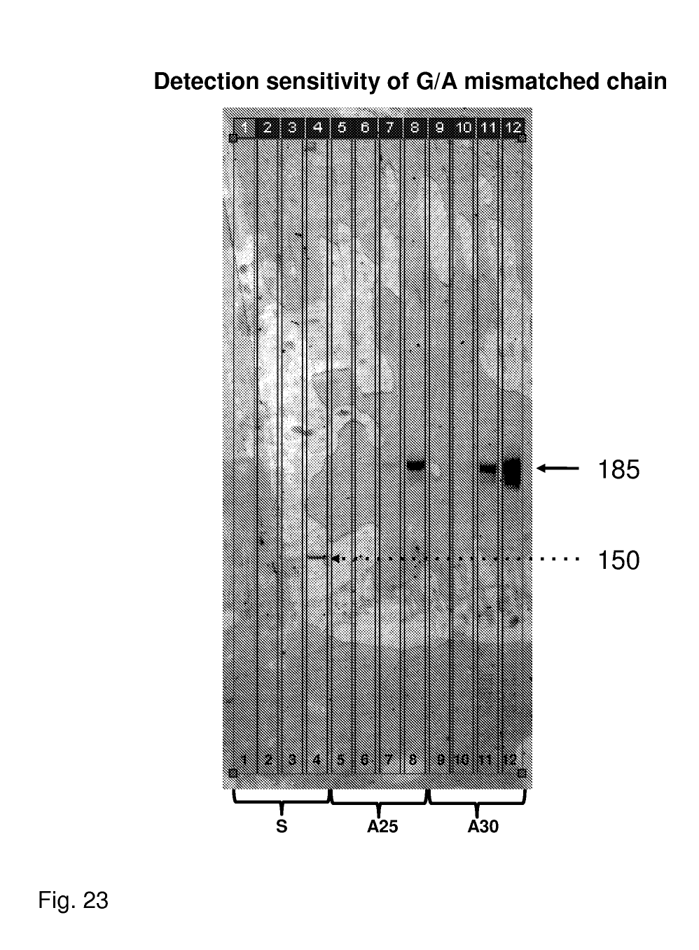

FIG. 23 is an experiment showing the detection sensitivity for identifying and selecting a G/A mismatched chain. DNA having a G/A mismatch was spiked into 0.5 pmol of perfectly matched DNA at the following different ratios of perfectly matched DNA/mismatched DNA: (1) 0.5/0, (2) 0.5/0.005, (3) 0.5/0.05 and (4) 0.5/0.5 (pmol/pmol). The spiked samples were then used in exonuclease III ladder synthesis reactions. The eluates from the beads after the selection reaction (labelled as “S”) are shown in lanes 1 to 4 (lane 1=ratio 1; lane 2=ratio 2; lane 3=ratio 3; and lane 4=ratio 4). The selected mismatched ladder was clearly observed when 0.5 pmol of mismatched DNA was spiked in the ladder synthesis reaction (lane 4). Mismatched DNA spiked in at 0.05 pmol or less in the initial ladder synthesis reaction did not give a detectable signal after selection (lanes 2 and 3). As expected, no selected mismatched DNA was observed in the sample having no spiked in mismatched DNA (lane 1).

The mismatch selected samples shown in lane 1 to 4 were then subjected to further tailing and amplification reactions, which are shown in lanes 5-8 (25 cycles of amplification; labelled A25 in FIG. 23) and lanes 9-12 (30 cycles of amplification; labelled A30 in FIG. 23). The correct amplicon was observed clearly at the expected 185 nt position from the mixture containing a 0.5/0.05 ratio of matched DNA/mismatched DNA (lane 11) (i.e., 10% mismatched DNA).

As detailed above, the exemplary process shown in FIG. 20 exploits (1) phosphorothioate linkage resistance to exonuclease III digestion; and (2) the ability of disrupted mismatched structure at (or around) the catalytic site of DNA polymerase to stall polymerization initiation.

We have found sequence-specific variations in both of the above biochemical processes, i.e., the resistance against exonuclease III and the detectable mismatched base combination using phosphorothioate nucleotide and Sequenase as a DNA polymerase.

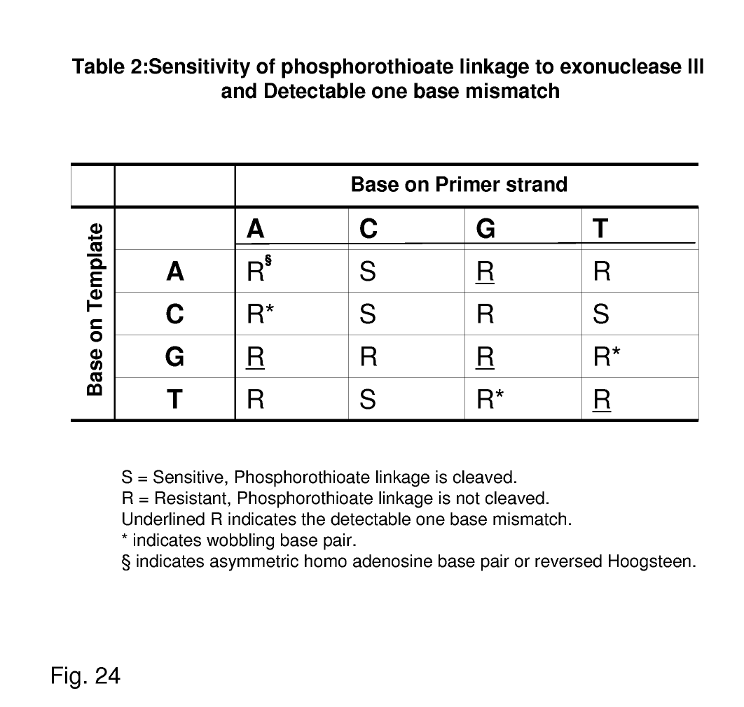

FIG. 24 provides Table 2, which details certain of these variations. In Table 2, S=Sensitive (phosphorothioate linkage is cleaved); R=Resistant (phosphorothioate linkage is not cleaved). Underlined R indicates the detectable one base mismatch. “*” indicates typical wobbling base pair. “§” indicates asymmetric homo-adenosine base pair or reverse Hoogsteen base pair.

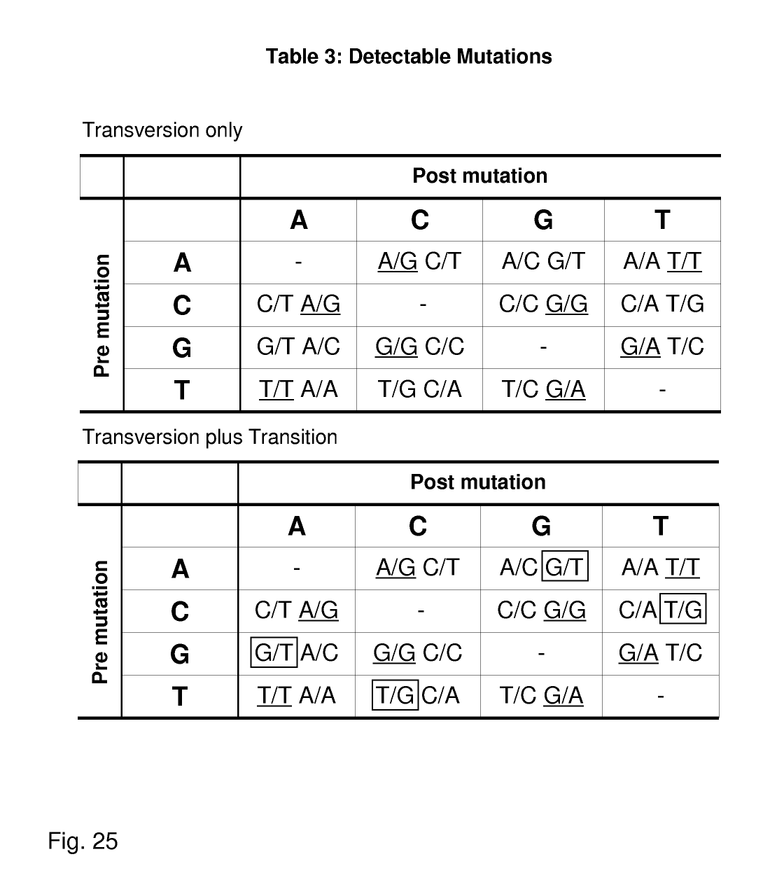

FIG. 25 provides Table 3 which shows mutations that are detectable by the exemplary mutation detection system described in this example. The top panel of Table 3 shows the detectable mutation by the current biotinylated nucleotide incorporation method, where the detectable mismatch is shown as underlined (the mismatches shown in the table represent the mismatches that would be present on the Watson and Crick strands; for example an A to C mutation would be represented on the Watson strand as a C/T mismatch and on the Crick strand as an A/G mismatch). The top panel if Table 3 shows that if we scan both on the Watson and Crick strands, we can detect transversion type mutations only.

This limitation of mutation detection is mainly due to two issues: 1) the exonuclease cleavage ability in the phosphorothioate linkage at mismatched C base; and 2) the ability of DNA polymerase to initiate polymerization from G/T or T/G wobbling base pairs.

To address issue 1 above, we can introduce an exonuclease resistant moiety that can prevent exonuclease III cleavage at C mismatches. One example is introducing a phosphodiester linkage that protects mismatched C bases from exonuclease cleavage at the 3′ end.

To address issue 2 above, disruption of G/T or T/G wobbling can be achieved by replacing the 2-exocyclic-oxygen atom of dTTP with selenium atom (see, e.g., J. AM. CHEM. SOC., February 2010, vol. 132(7) 2120-2121). Selenium is a poor hydrogen acceptor and relatively large atom, and thus introduction of a selenium atom at position 2 of dTTP increases the electronic and steric effects between G/T or T/G wobbling base pairs, resulting in strong wobbling base pair discrimination. Moreover, because the 2-exocyclic-oxygen atom is not involved in A/T base pairing, it will not disrupt this normal base pairing. Therefore, instead of using dTTP-alpha phosphorothioate, we can use 2-Se-dTTP-alpha phosphorothioate in the T ladder formation. The use of this strategy makes it possible to detect additional G/T or T/G mutations shown in the bottom panel of Table 3 in boxes (mutations detectable in the top panel are still underlined). As seen in the bottom panel, this strategy will allow the detection of all 12 different mutations (transitions and transversions) when analyzing both Watson and Crick strands. Note that in case of G ladder formation, dTTP should be replaced with 2-Se-dTTP to prepare bottom reference strand to disrupt the G/T wobbling, where G is on the first/primer strand and T is on the template strand.

The exemplary mutation detection process described in this example is distinct from other mutation detection processes that rely on mutation detection proteins (e.g., CEL I, MutS, T7 endonuclease etc.) which show a preference for the recognition of base mismatches. Specifically, the exonuclease III/DNA polymerase system described here can be used to detect any mutation (transitions and transversions), and thus has no inherent preference for the mismatches to be detected.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A method for isolating a polynucleotide having a sequence variation comprising:
contacting a sample comprising polynucleotide duplexes comprising a test strand and a template strand with a nucleic acid polymerase and nucleotides under nucleic acid synthesis conditions, wherein:
the polynucleotide duplexes have a 5′ overhang region on the template strand;
the 3′ terminal nucleotide on the test strand has a nucleotide linkage that is resistant to 3′ to 5′ exonuclease activity; and
one or more of the polynucleotide duplexes comprise a test strand having a 3′ terminal nucleotide mismatched with the template strand; and
isolating test strands that have not incorporated nucleotides in the contacting step, thereby isolating polynucleotides having a sequence variation.

2. The method of claim 1, wherein the template strand is attached to a solid phase support prior to the contacting step, thereby immobilizing the polynucleotide duplexes to the solid phase support.

3. The method of claim 2, wherein the template strand is attached to the solid phase support via a binding moiety/binding partner interaction.

4. The method of claim 1, wherein one or more nucleotide in the contacting step comprises a binding moiety, wherein the isolating step comprises contacting the sample with a second solid phase support comprising a binding partner for the binding moiety of the one or more nucleotide to remove test strands that have incorporated nucleotides in the first contacting step.

5. The method of claim 4, wherein the method further comprises blocking unoccupied binding partners on the solid phase support to which the template strand is attached prior to the first contacting step.

6. The method of claim 2, wherein the template strand is attached to the solid phase support via hybridization to a capture primer attached to the solid phase support, wherein the capture primer is specific for a capture primer binding site in the 5′ overhang region on the template strand.

7. The method of claim 6, wherein the nucleic acid polymerase in the contacting step is a strand-displacing nucleic acid polymerase, wherein the strand-displacing activity of the nucleic acid polymerase displaces the annealed capture primer from the template strand of polynucleotide duplexes that can initiate nucleic acid synthesis, and wherein the isolating step comprises isolating test strands hybridized to template strands that remain attached to the solid phase support after the contacting step.

8. The method of claim 1, wherein the wherein the test strands of the polynucleotide duplexes in the sample are derived from multiple different polynucleotide sources, each test strand further comprising a multiplex identifier (MID) indicative of its polynucleotide source.

9. The method of claim 1, wherein the polynucleotide duplexes are produced by:
hybridizing a parent test polynucleotide strand to a parent template polynucleotide strand to produce a parent polynucleotide duplex, wherein the parent test strand comprises one or more randomly positioned nucleotide linkages resistant to 3′ to 5′ exonuclease activity and the 3′ end of the parent template strand is protected from 3′ to 5′ exonuclease activity; and
treating the parent polynucleotide duplex with an enzyme having 3′ to 5′ exonuclease activity.

10. The method of claim 9, wherein:
the parent test strand comprises the following elements in a 5′ to 3′ orientation: a multiplex identifier (MID) indicative of its source, a reflex site, and a region of interest; and
the parent template strand comprises the following elements in a 5′ to 3′ orientation: a substantial complement of the region of interest and a complement of the reflex site;
wherein the MID of the parent test strand is present in a 5′ overhang region of the parent polynucleotide duplexes and the hybridization region of the parent polynucleotide duplex comprises the reflex site and the region of interest of the parent test strand and the complement of the reflex site and the substantial complement of the region of interest of the parent template strand.

11. The method of claim 1, further comprising tailing the isolated test strands with a polynucleotide tail using terminal deoxynucleotidyl transferase (TdT).

12. The method of claim 11, further comprising:
amplifying the tailed isolated test strands using a nucleic acid synthesis primer specific for the polynucleotide tail of the test strands; or
ligating an adapter to the 3′ terminus of the tailed test strands, wherein the adapter comprises a double stranded region and an attachment site comprising a 3′ overhang region complementary to the 3′ terminus of the tailed test strands.

13. A method for isolating a polynucleotide having a sequence variation comprising:
generating a sample comprising polynucleotide duplexes having a test strand and a template strand, wherein the polynucleotide duplexes have a 5′ overhang region on the template strand and wherein one or more of the polynucleotide duplexes comprise a test strand having a sequence variation at the 3′ terminal nucleotide that results in a nucleotide base mismatched with the template strand;
contacting the sample with a nucleic acid polymerase under nucleic acid synthesis conditions in the presence of dideoxynucleotide triphosphates (ddNTPs);
contacting the sample with an enzyme having terminal transferase activity and nucleotide triphosphates;
isolating test strands tailed with three or more nucleotides via terminal transferase activity, thereby isolating polynucleotides having a sequence variation.

14. A method for isolating a polynucleotide having a sequence variation comprising:
generating a sample comprising polynucleotide duplexes having a test strand and a template strand, wherein the polynucleotide duplexes have a 5′ overhang region on the template strand and wherein the sample comprises:
one or more mismatched polynucleotide duplexes comprising a test strand having a sequence variation at the 3′ terminal nucleotide that results in a nucleotide base mismatched with the template strand; and
one or more matched polynucleotide duplexes comprising a test strand having a matched 3′ terminal nucleotide; and
hybridizing one or more blocking oligonucleotide to the polynucleotide duplexes, wherein the one or more blocking oligonucleotide hybridizes at a site immediately adjacent to the 3′ terminal nucleotide of the matched polynucleotide duplexes;
contacting the sample with an enzyme having ligase activity, wherein the blocking oligonucleotide is ligated to the test strand of the matched polynucleotide duplexes;
contacting the sample with an enzyme having terminal transferase activity and nucleotide triphosphates; and
isolating test strands tailed with three or more nucleotides via terminal transferase activity, thereby isolating polynucleotides having a sequence variation.

15. The method of claim 1, wherein the isolated polynucleotides are sequenced to identify a signature sequence and the mismatched base.

16-19. (canceled)
